(19) United States
(12) Patent Application Publication
(10) Pub. No.: US 2024/0070592 A1
(43) Pub. Date: Feb. 29, 2024

(54) METHODS AND SYSTEMS EMPLOYING PROFESSIONAL CULTURE TRAITS TO EVALUATE COMPATIBILITY BETWEEN INDIVIDUALS OR GROUPS OF INDIVIDUALS

(71) Applicant: Torre Labs, Inc., San Jose, CA (US)

(72) Inventors: Alexander Henriquez Torrenegra, Napa, CA (US); Daniela Alejandra Avila Gomez, Cajica (CO); Renan Peixoto da Silva, São Paulo (BR); Roy Ten Berge, Valkenswaard (NL); Marco Alejandro Acosta Anaya, Guaduas (CO); Kubilay Caglayan, Ankara (TR); Jorge Andres Bocanegra Avendaño, Bogota (CO); Juan Francisco Laso Delgado, Guayaquil (EC)

(73) Assignee: Torre Labs, Inc., San Jose, CA (US)

(21) Appl. No.: 18/238,006

(22) Filed: Aug. 25, 2023

Related U.S. Application Data
(60) Provisional application No. 63/401,880, filed on Aug. 29, 2022.

(51) Int. Cl. G06Q 10/0639; G06Q 50/00

(52) U.S. Cl. CPC G06Q 10/06393; G06Q 50/01

(57) ABSTRACT

Computer-implemented methods and systems are provided for characterizing compatibility between a source group and a target group. Individuals of the source and target groups interact with an electronic-form questionnaire related to a predefined set of professional traits to collect and store question-specific response data to the questionnaire. The question-specific response data is processed to generate a score related to compatibility of the source group and the target group. The question-specific response data is further processed to assign the professional traits to labels that relate to compatibility of the source group and the target group for highlight purposes. The score and additional information based on the traits-to-labels assignment can be presented for display for evaluation of compatibility of the source group and the target group. The score and additional information can characterize the natural ability of the individuals of the source group and the target group to work together in harmony because of well-matched characteristics and cultural fit. The individuals of the source and target groups can include users of a business-oriented social network or other service or platform (such as an online job marketplace or matching network for work). Other details are described and claimed.

### CROSS-REFERENCE TO RELATED APPLICATION(S)

The present disclosure claims priority from U.S. Provisional Appl. No. 63/401,880 filed on Aug. 29, 2023, herein incorporated by reference in its entirety.

### BACKGROUND

### 1. Field

The present disclosure relates to business-oriented services, platforms or sites, such as business-oriented social networks, online job marketplaces, and matching networks for work.

### 2. State of the Art

A social network can be implemented as an online service, platform or site that allows users to build or reflect social networks or social relations among users of the social network. Typically, users construct profiles, which may include personal information such as name, contact information, employment information, photographs, personal messages, status information, links to web-related content, blogs, and so on. Typically, only a portion of a user's profile may be viewed by the general public and/or by other users.

The social network allows users to identify and establish connections with other users in order to build or reflect relations among users.

A business-oriented social network is a type of social network that allows users to establish a connection with his or her business contacts, including work colleagues, clients, customers, and so on. A connection is generally formed using an invitation process in which one user “invites” a second user. The second user than has the option of accepting or declining the invitation.

In the context of business-oriented social networks, users may often specify a list of their professional experiences as part of their user profiles. Such professional experiences can include past and/or present jobs, projects, educational degrees or certificates, interests, skills, and/or other experiences. Note that other users, businesses, and their agents can manually review these professional experiences to evaluate compatibility between users or groups of users based on some target criteria. Such manual review is time-consuming, costly, and entirely subjective in nature.

Other services and platforms, such as online job marketplaces and matching networks for work, enable users and businesses and their agents to evaluate compatibility between users or groups of users based on some target criteria. Such evaluation is time-consuming, costly, and entirely subjective in nature.

### SUMMARY

Computer-implemented methods and systems are provided for characterizing compatibility between a source group and a target group. The individual(s) of the source group and the individual(s) of the target group interact with an electronic-form questionnaire related to a predefined set of professional traits to collect and store question-specific response data to the questionnaire for the source and target groups, respectively. The question-specific response data for the source group and target group is processed to generate a score related to compatibility of the source group and the target group. The question-specific response data for the source group and target group is further processed to assign professional traits to labels that relate to compatibility of the source group and the target group for highlight purposes. The score and additional information is presented for display for evaluation of compatibility of the source group and the target group. The additional information is based on the assignment of professional traits to labels. The score and additional information can characterize the natural ability of the individuals of the source group and the target group to work together in harmony because of well-matched characteristics and cultural fit.

In embodiments, the individuals of the source group and the target group can include users of a business-oriented social network or other platform or service (such as an online job marketplace or matching network for work). In embodiments, the operations of the methods described herein can be integrated into the functionality of the network or platform or service.

In embodiments, one or more observers of the individual(s) of the source group can interact with the same or similar electronic-form questionnaire to obtain and store response data related to the predefined set of professional traits of the individual(s) of the source group, and one or more observers of the individual(s) of the target group can interact with the same or similar electronic-form questionnaire to obtain and store response data related to the predefined set of professional traits of the individual(s) of the target group. The observer response data for the source group and the observer response data for the target group can be processed to assign the labels to the predefined set of professional traits.

In embodiments, the additional information can be configured to convey the effect of the predefined set of professional traits on the compatibility of the source group and the target group.

In embodiments, at least part of the additional information can be configured to convey the effect of the predefined set of professional traits on the compatibility of the source group and the target group from the perspective of the source group.

In embodiments, at least part of the additional information can be configured to convey the effect of the predefined set of professional traits on the compatibility of the source group and the target group from the perspective of the target group.

In embodiments, the labels can represent at least one class of professional traits where the source group and the target group likely both have a professional trait.

In embodiments, the labels can represent at least one class of professional traits where the source group and the target group likely both do not have a professional trait.

In embodiments, the labels can represent at least one class of professional traits where the source group likely has a professional trait and the target group likely does not have the professional trait.

In embodiments, the labels can represent at least one class of professional traits where the target group likely has a professional trait and the source group likely does not have the professional trait.

In embodiments, the labels can represent at least one class of professional traits where the source group would likely influence the target group to have more of a professional trait.

In embodiments, the labels can represent at least one class of professional traits where the source group would likely influence the target group to have less of a professional trait.

In embodiments, the labels can represent at least one class of professional traits where the target group would likely influence the source group to have more of a professional trait.

In embodiments, the labels can represent at least one class of professional traits where the target group would likely influence the source group to have less of a professional trait.

In embodiments, the score can be generated from question-specific calculations that generate statistical parameters that account for response data collected from a larger number of individuals beyond the source group and the target group.

In embodiments, the score can be generated from at least one of the following:
question-specific relevance factors with respect to the source group that represent weights that reflect amount of separation in the responses of the source group relative to question-specific global averages and deviations, and
question-specific relevance factors with respect to the target group that represent weights that reflect amount of separation in the responses of the target group relative to the question-specific global averages and deviations.
question-specific similarity factors that reflect similarity or difference between the responses of the source group and the target group.
question-specific importance factors with respect to the source group that are based on distribution of responses in the source group, and
question-specific importance factors with respect to the target group that are based on distribution of responses in the target group.

In embodiments, professional traits that relate to the compatibility of the source group and the target group can be ranked from the perspective of the source group. Such ranking can be based on question-specific factors with respect to the source group. For example, the question-specific factors with respect to the source group can be question-specific relevance factors with respect to the source group that represent weights that reflect amount of separation in the responses of the source group relative to a question-specific global averages and deviations.

In embodiments, professional traits that relate to the compatibility of the source group and the target group can be ranked from the perspective of the target group. Such ranking can be based on question-specific factors with respect to the target group. For example, the question-specific factors with respect to the target group can be question-specific relevance factors with respect to the target group that represent weights that reflect amount of separation in the responses of the target group relative to a question-specific global averages and deviations.

In embodiments, the labels can be configured to include the following:
i) labels that correspond to at least one class of professional traits where the source group would likely influence the target group to have more of a professional trait;
ii) labels that correspond to at least one class of professional traits where the source group would likely influence the target group to have less of a professional trait;
iii) labels that correspond to at least one class of professional traits where the target group would likely influence the source group to have more of a professional trait; and
iv) labels that correspond to at least one class of professional traits where the target group would likely influence the source group to have less of a professional trait.

In embodiments, professional traits can be assigned to the classes of i) to iv) based on statistical parameters that account for differences between the responses of the source group and the responses of the target group.

In embodiments, professional traits can be assigned to the classes of i) and ii) based on statistical parameters calculated from the response data for the target group as provided by individual(s) and/or observer(s) of the target group.

In embodiments, professional traits can be assigned to the classes of iii) and iv) based on statistical parameters calculated from the response data for the source group as provided by individual(s) and/or observer(s) of the source group.

Other details and aspects are described and claimed.

### BRIEF DESCRIPTION OF THE DRAWINGS

FIG. 1 is a schematic illustration of an exemplary business-oriented social network system.

FIG. 2 is a flowchart illustrating an exemplary method that presents a predefined set of statements to users of the social network system and collects and stores response data for such statements which relates to the professional traits of such users in accordance with the present disclosure.

FIGS. 3A to 3P, collectively, is a flowchart illustrating an exemplary method for evaluating business-oriented compatibility between a source group and a target group of the social network system in accordance with the present disclosure.

FIGS. 4A, 4B, 4C, 5A, 5B, 5C, 6 and 7 depict exemplary graphical user interfaces that can be presented by the social network system for display on user computer systems, which can be used as part of the method of FIGS. 3A to 3P.

FIG. 8 is a chart that specifies a number of paired professional traits and single professional traits that can be used to evaluate business-oriented compatibility between a source group and a target group of the social network system in accordance with the present disclosure.

FIG. 9 is a schematic view of an example computer system.

### DETAILED DESCRIPTION OF THE PREFERRED EMBODIMENTS

In the following, a detailed description of examples will be given with references to the drawings. It should be understood that various modifications to the examples may be made. In particular, elements of one example may be combined and used in other examples to form new examples.

Many of the examples described herein are provided in the context of a business-oriented social networking website or service. However, the applicability of the inventive subject matter is not limited to business-oriented social networking websites or platforms.

As used herein, a “professional trait” of an individual or user shall mean a personal characteristic of the individual or user related to a profession or business environment. The professional traits can include single traits, such as the following:
able to manage time
ambitious
calm
careful
committed
communicative
competitive
conflict-resolver
confrontational
curious
customer-oriented
desiring job security
detail-oriented
listener
persistent
persuasive
proactive
problem solver
results-oriented
responsible
self-learner
simplicity-driven
tolerant
trustworthy
workaholic

The traits can also include trait pairs that are generally opposite one another, such as
critical/appreciative
quality-oriented/speed-oriented
autonomous worker/team-worker
diplomatic/honest
creative/consistent or predictable
loyal/pragmatic
risk-taker/cautious
assertive/modest
fast/analytical
reacts emotionally/reacts rationally
following/leading
adaptable/stability-focused
methodical/spontaneous
rules-oriented/innovative
future-focused/present-focused
impact-focused/profit-focused
optimistic/realistic
journey-focused/destination-focused
listener/communicative
ambitious/easygoing
reserved/transparent
tolerant/demanding
self-learner/formal-learner
customer-focused/company-centric
proactive/reactive
results-oriented/process-oriented
extroverted/introverted
casual/mindful
progressive/conservative
hard-worker/relaxed
lax/accurate
chaotic/perfectionist
impulsive/deliberate
rigorous/chill
critical/friendly
respectful/assertive
   Other professional traits can be included, if desired.

As used herein, a “question” refers to words (such as a short sentence) or other information that elicits a response from an individual that can be used to characterize a professional trait of that individual. In embodiments, the response can indicate a range of agreement or disagreement with respect to the question by the individual, e.g., strongly agree, agree, neutral (neither agree nor disagree), disagree, strongly disagree. In other embodiments, the response to a question can indicate how often (from “never” to “all the time”) the trait is characteristic of that individual. In embodiments, some or all of the questions and corresponding responses can relate to particular personality traits on a one-to-one basis. In this configuration, a particular question and corresponding response can be used to characterize one professional trait (or one professional trait-pair) of the respondent that is mapped to that question and response. Additionally or alternatively, some or all of the questions and corresponding responses can relate to particular personality traits on a many-to-one basis. In this configuration, a group (plurality) of questions and corresponding responses can be used to characterize the professional trait of the respondent that is mapped to that group (plurality) of questions and responses.

As used herein, a “graphical user interface” is a user interface that is presented to a user operating an electronic device and configured to allow the user to interact with the electronic device through visual/graphical elements, such as menu tabs, selector bars, selector buttons, icons, check boxes, virtual keyboard, etc. The graphical user interface can be configured as one or more display windows presented to the user of the electronic device where the display window(s) include information together with one or more visual/graphical elements for the user interaction. The user interaction can be provided by a pointing device (e.g., mouse, touchpad, or trackball), touch input, voice input control or other suitable user input. The user actions are usually performed through direct manipulation of the visual/graphical elements.

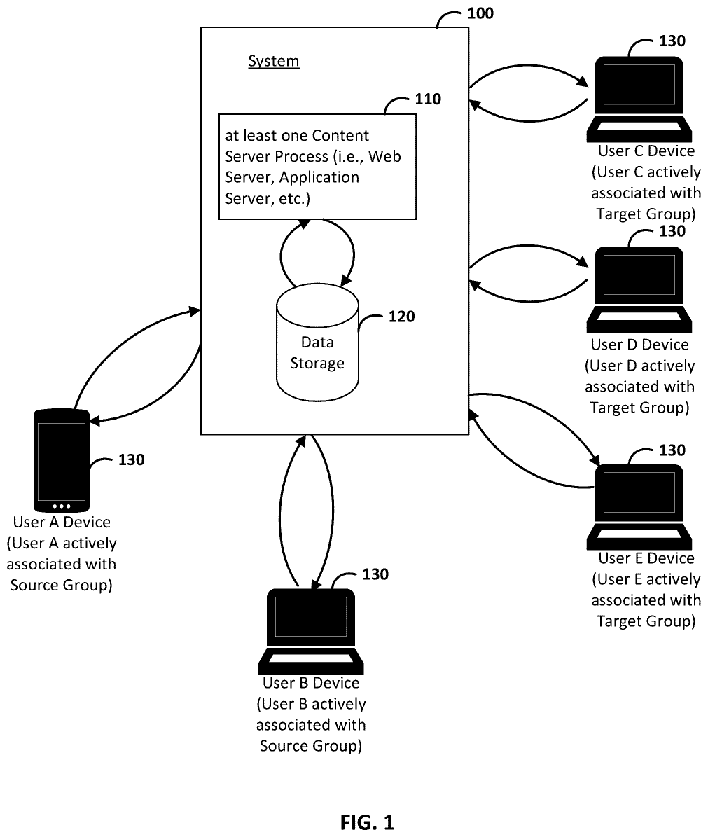

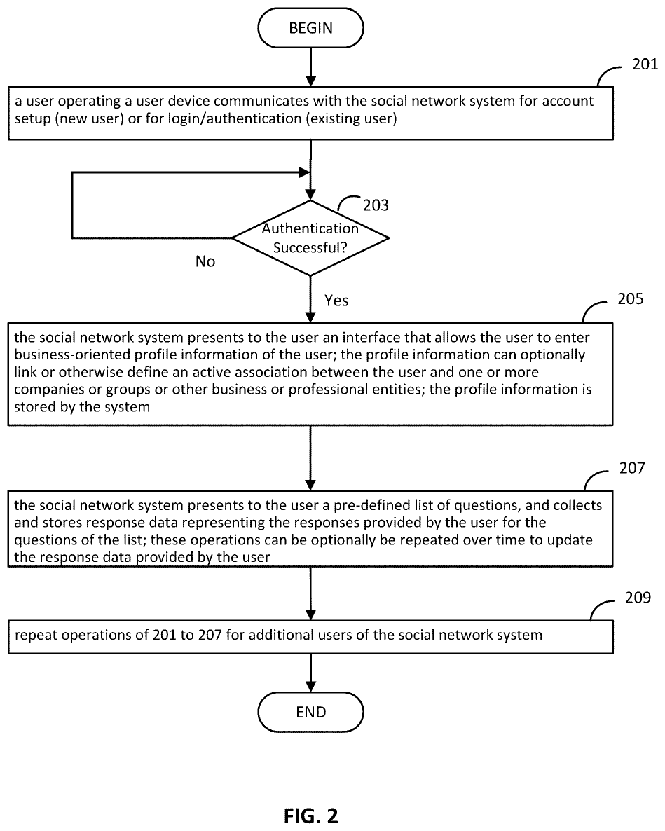

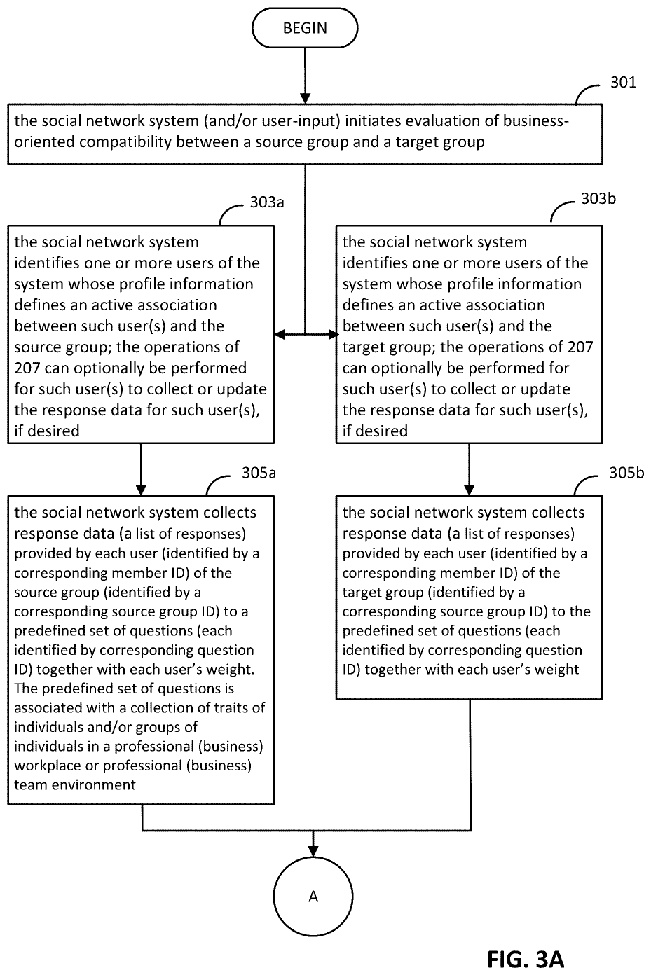

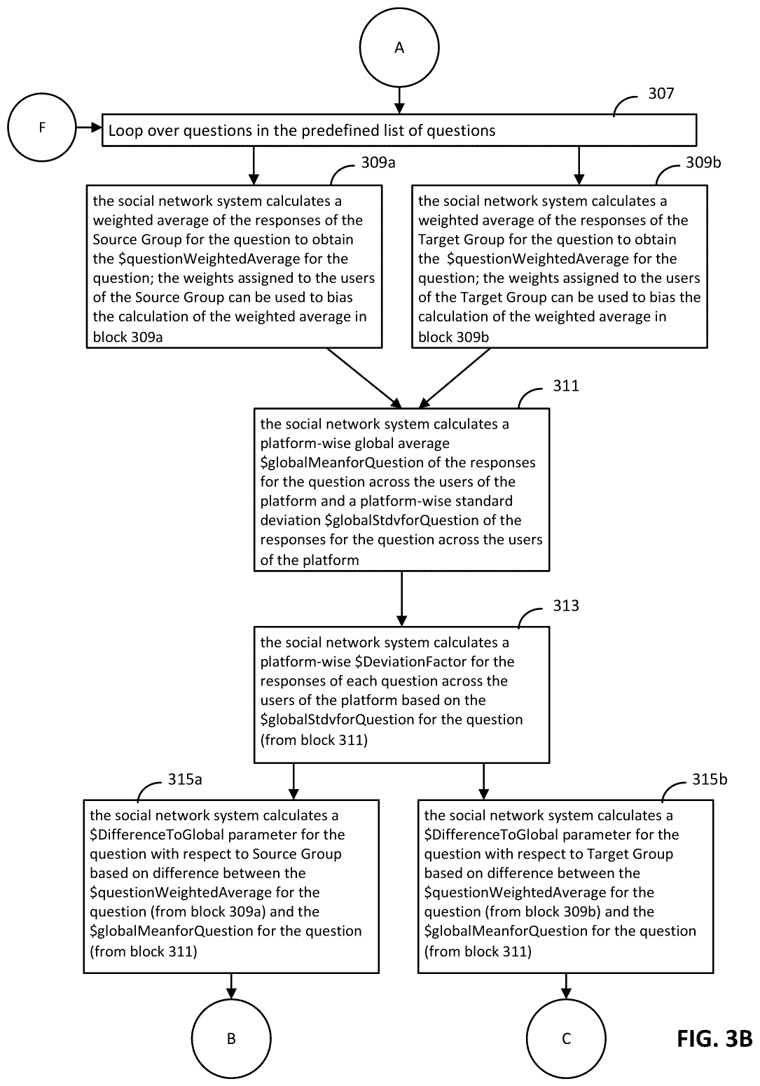

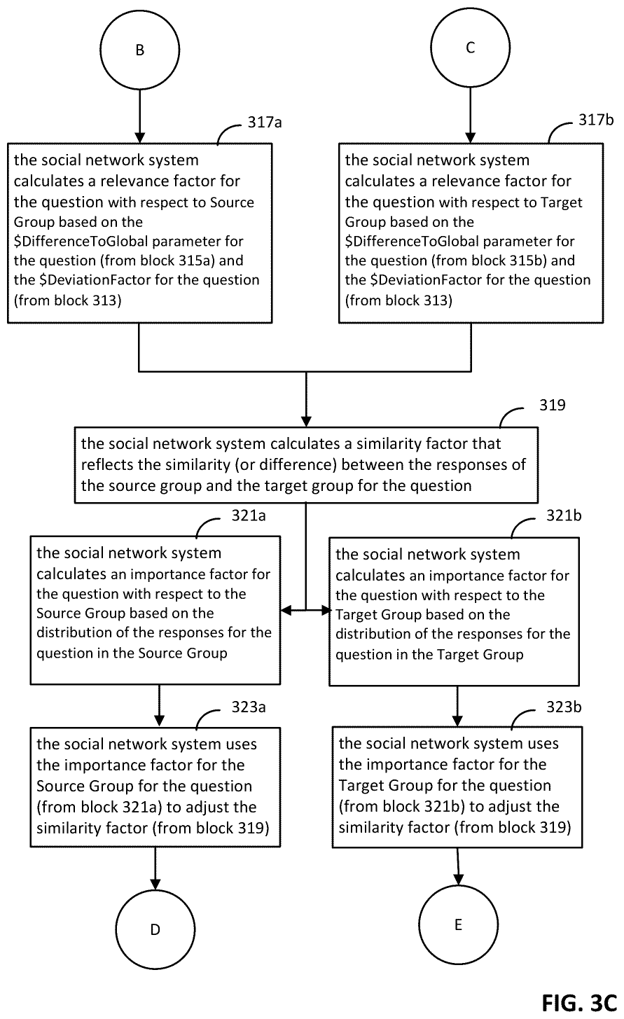

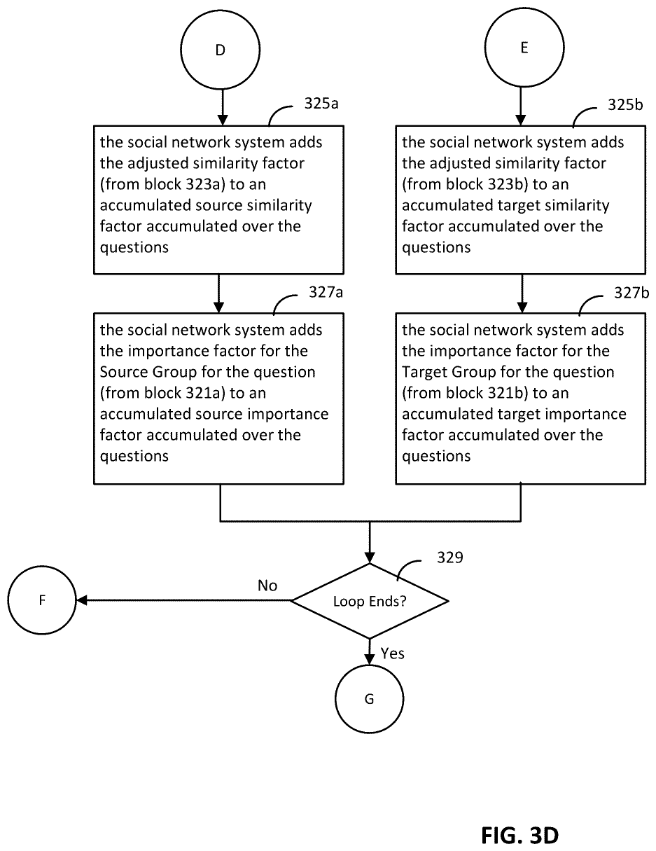

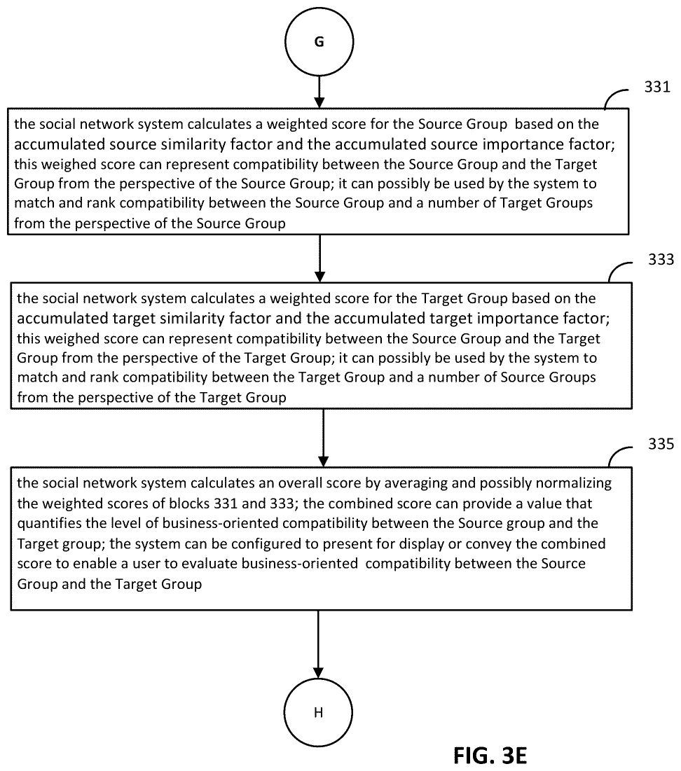

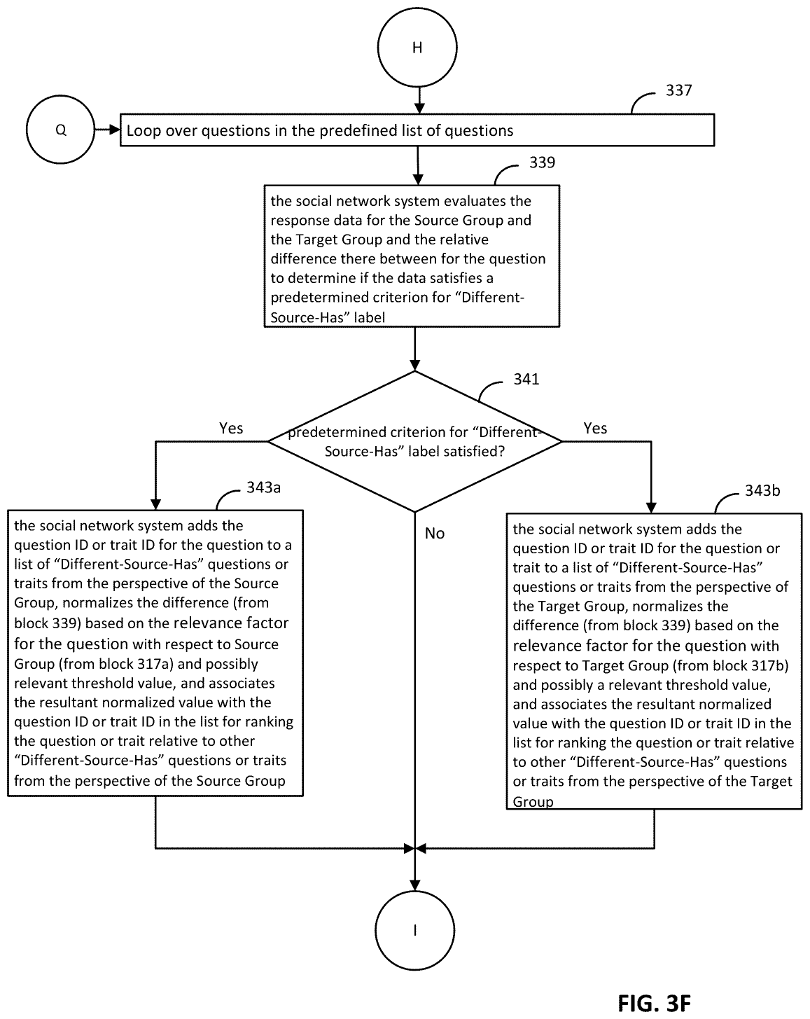

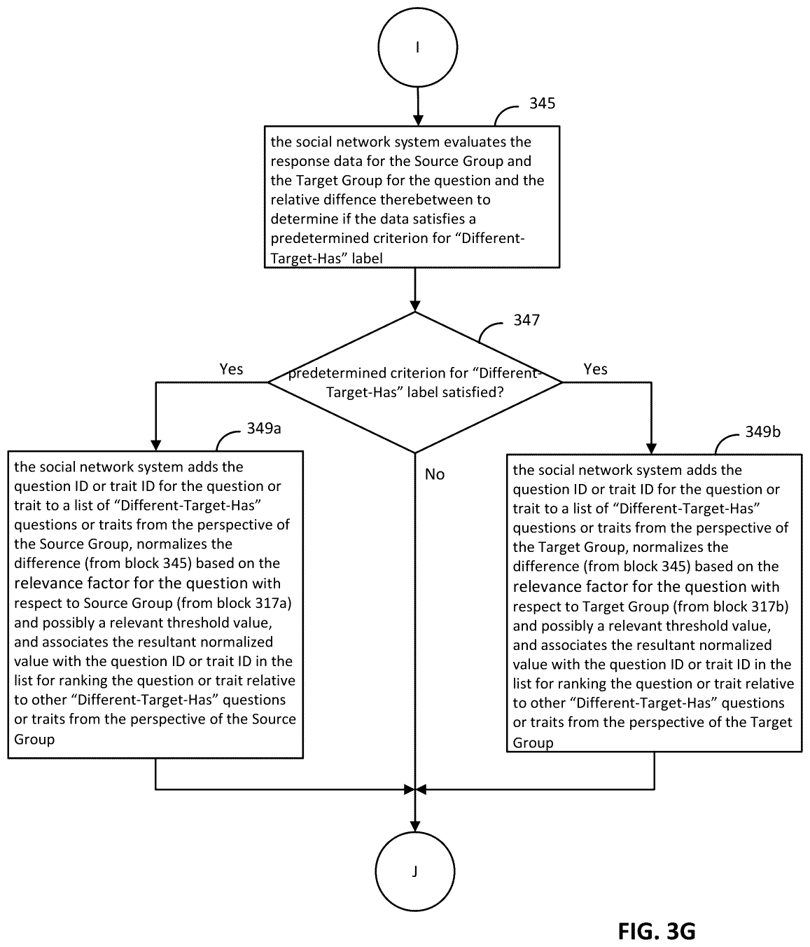

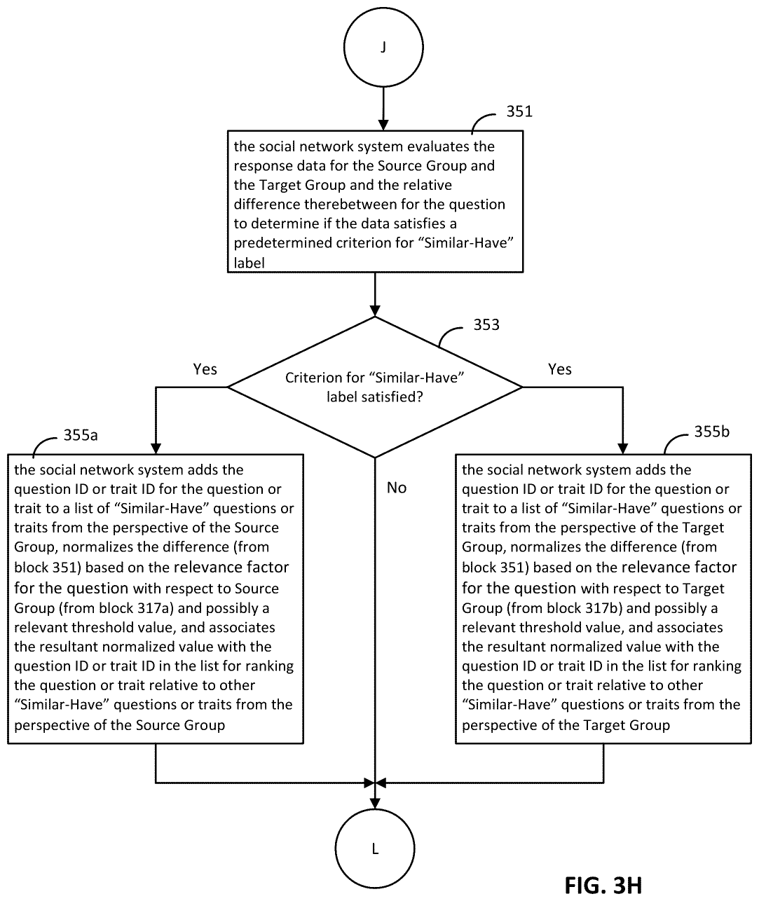

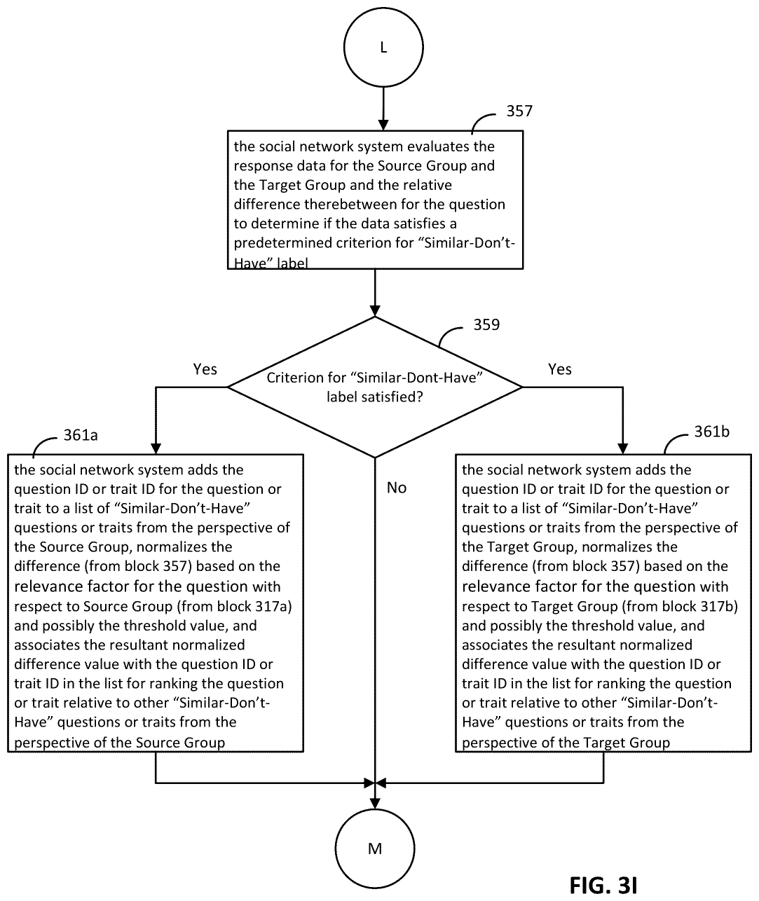

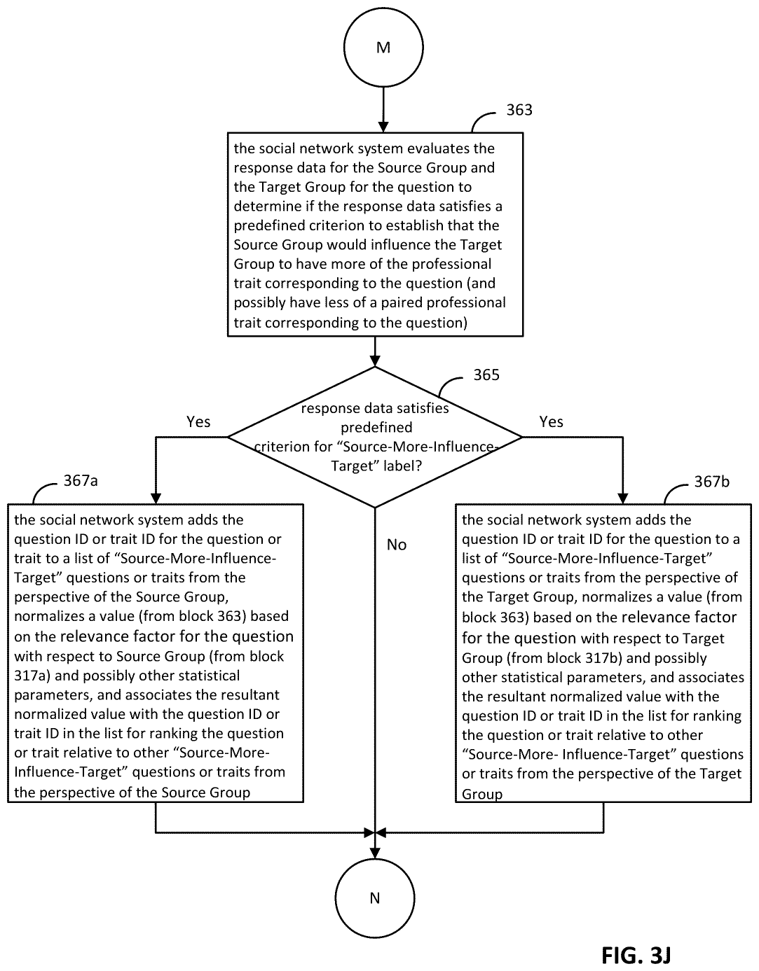

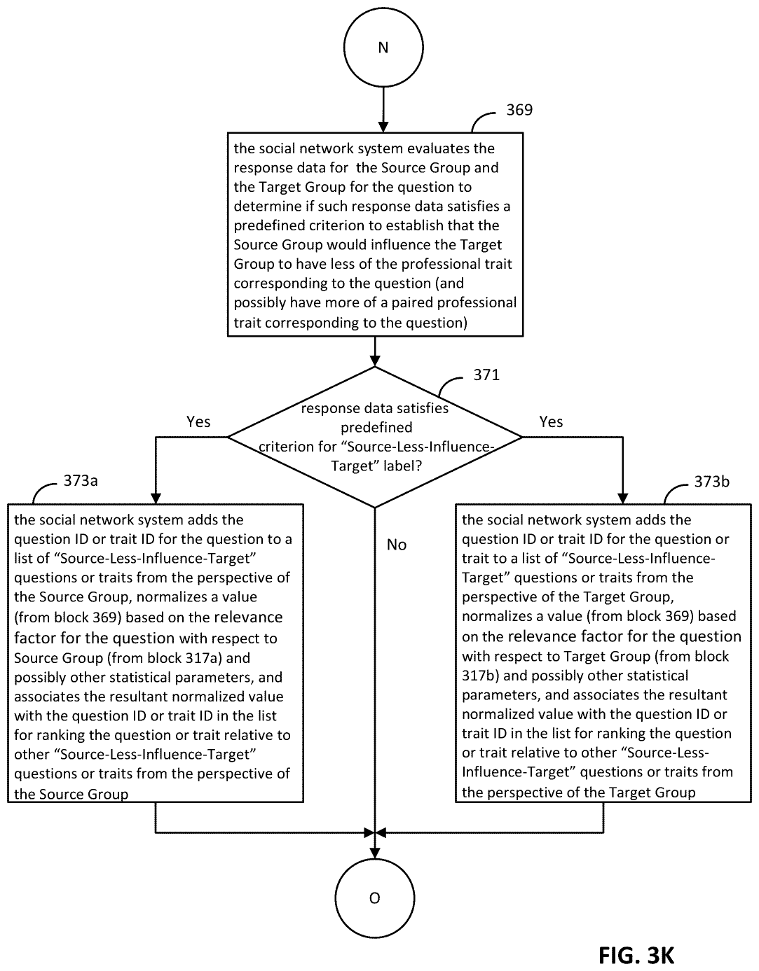

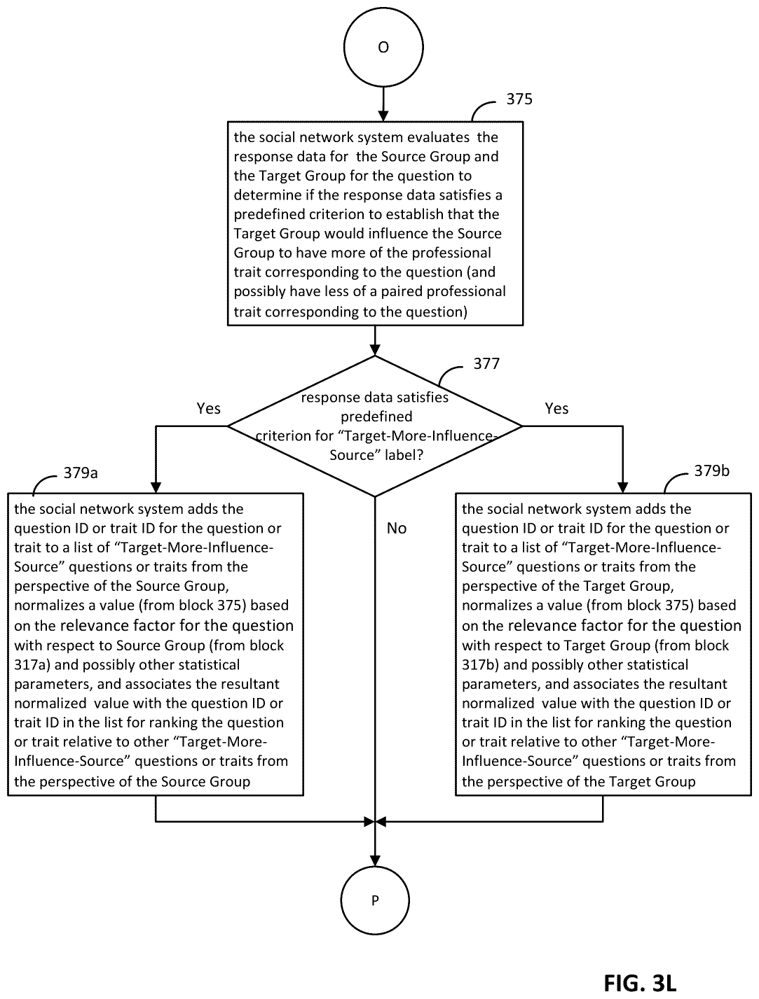

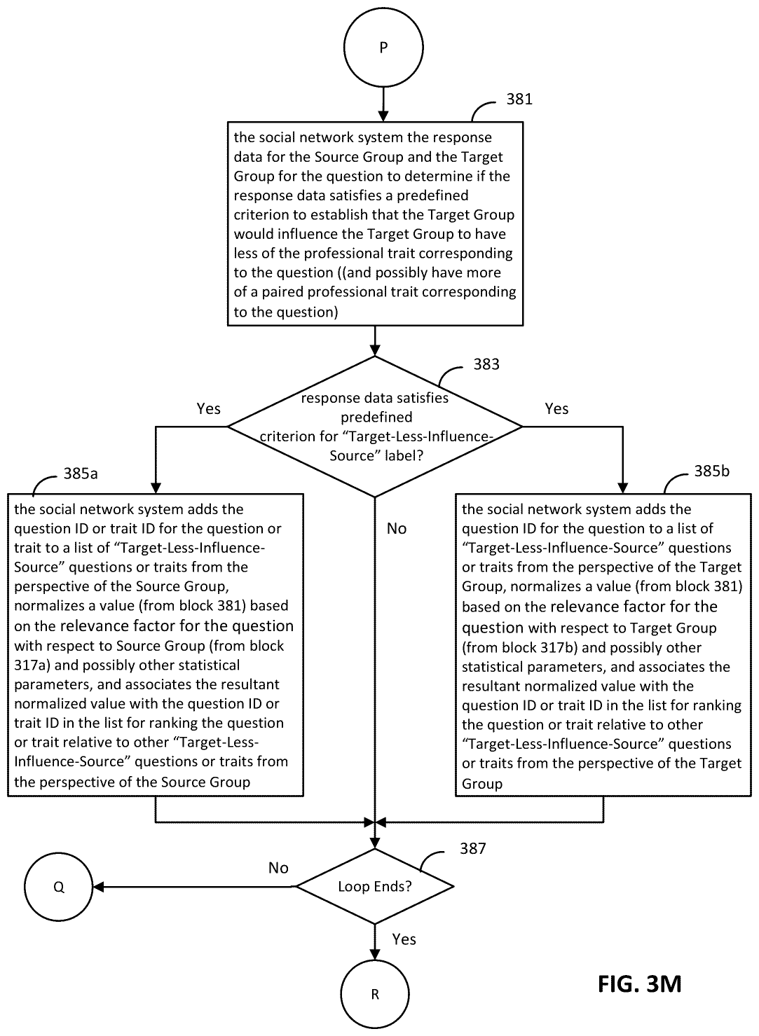

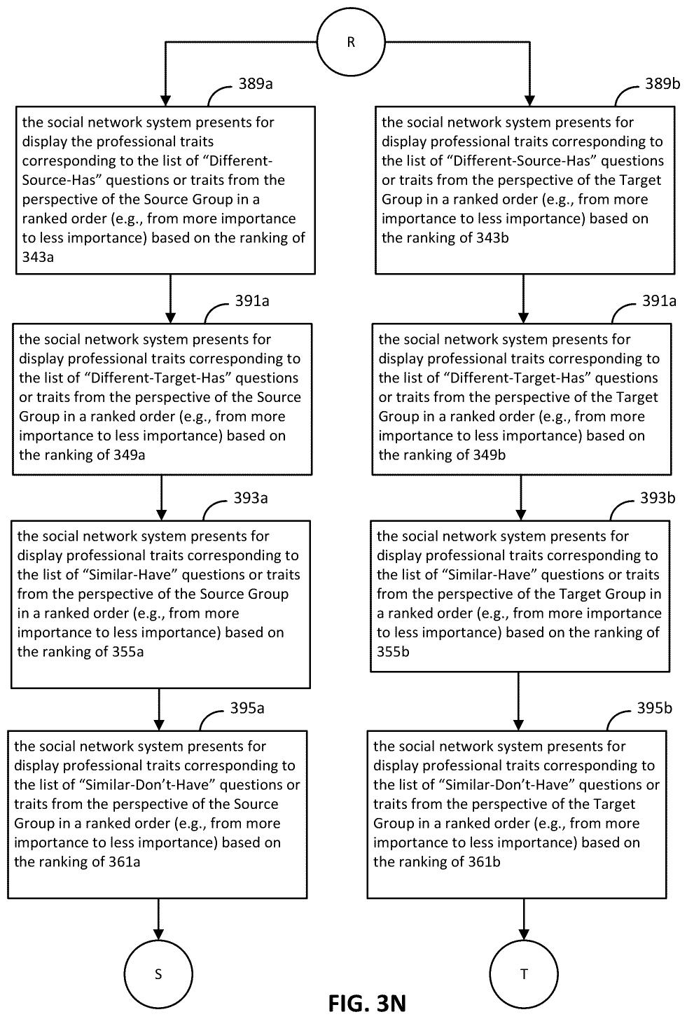

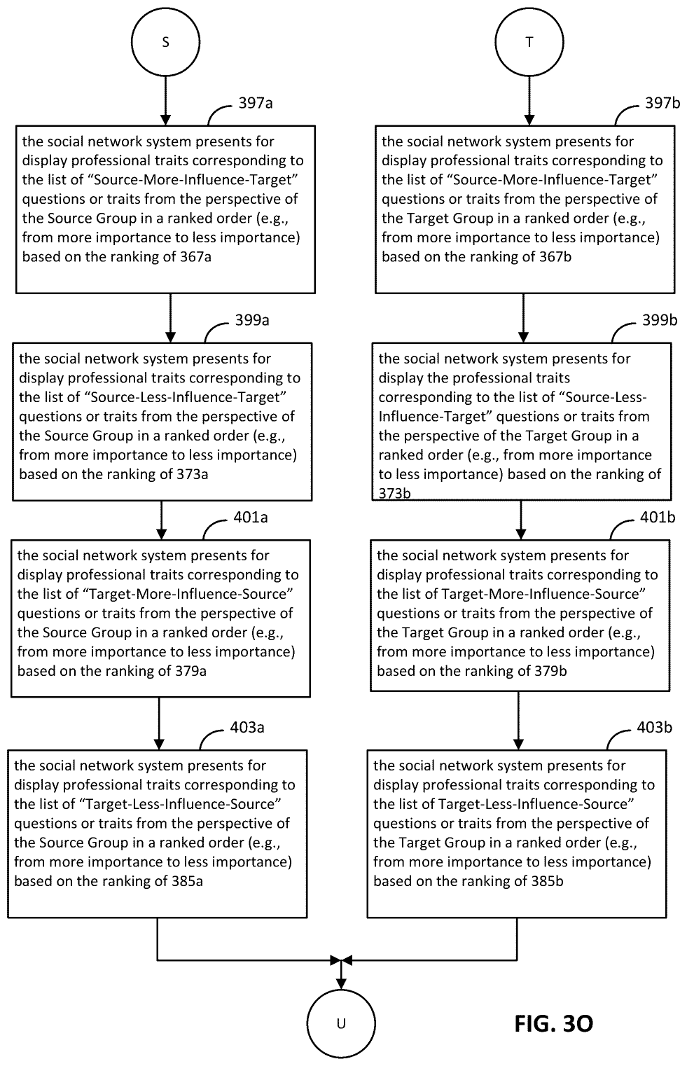

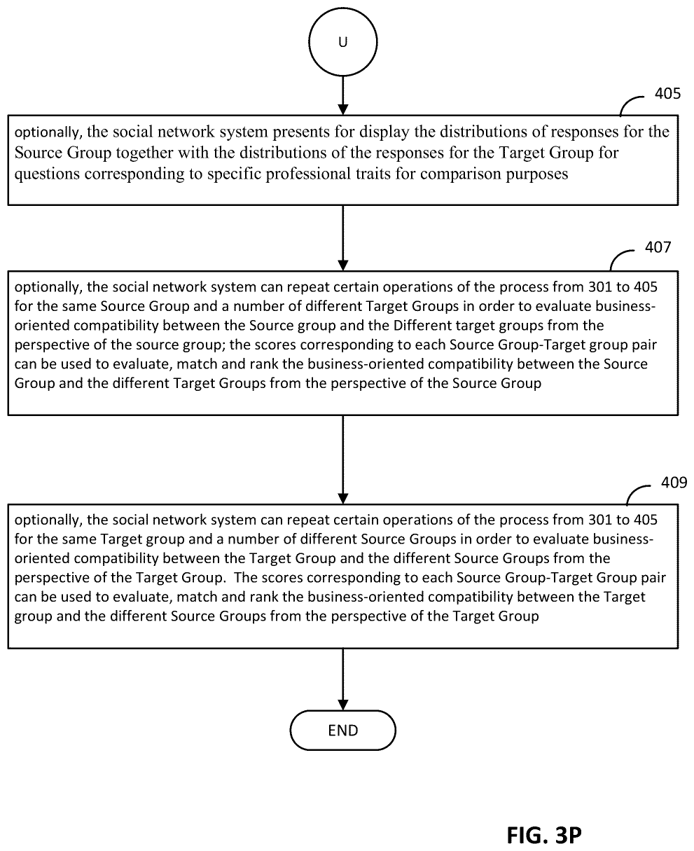

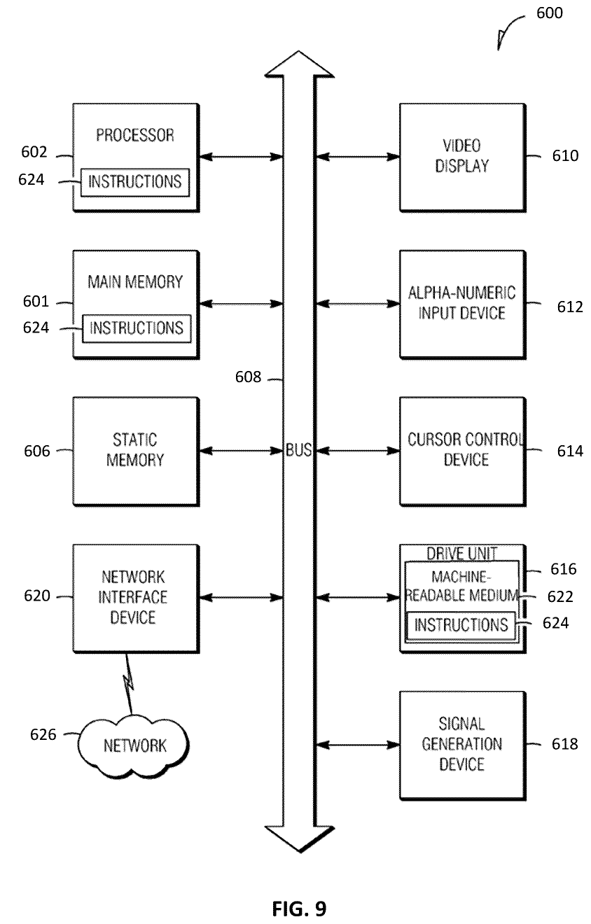

FIG. 1 shows an exemplary business-oriented social network system 100 according to one example of the current disclosure. The social network system 100 may contain one or more content server processes 110. The one or more content server processes 110 can be implemented on a computer processing system (for example, as described below with respect to FIG. 9) and can communicate with a data storage system 120 and users through a communication network. The one or more content server processes 110 may be responsible for the retrieval, presentation, and maintenance of registered user profile information stored in data storage 120 and interaction with the users according to the operations of FIG. 2 and FIGS. 3A-3P as described herein in detail. In embodiments, the one or more content server processes 110 may include or be a web server and/or application server that fetches or creates internet web pages, which may include portions of, or all of, a registered user profile information and other information at the request of users.

Users may be an individual, member, prospective user, recruiter or employer, or other users of the social network 100. Users access the social network system 100 using a device 130 through a communication network. The communication network may be any means of enabling the social network 100 to communicate data with a computer remotely, such as the internet, an extranet, a LAN, WAN, wireless, wired, or the like, or any combination. The device 130 can be any one of a number of different types of processor-based devices, including PCs, workstations, notebooks, tablets, smartphones, other mobile devices, and other data communication enabled devices. In the exemplary business-oriented social network 100, five users are shown, where users A and B are actively associated with a source group as referred to herein and users C, D, and E are actively associated with a target group as referred to herein. It is expected that a larger number of users will access and use the system.

FIG. 2 presents a high-level view of a method implemented by a business-oriented social network according to one example implementation.

In block 201, a user operating a user device (e.g., device 130 of FIG. 1) communicates with a social network system (e.g., system 100 of FIG. 1) for account setup (new user) or for login/authentication (existing user). Such login/authentication involve the user specifying a username and authentication mechanism such as password or other form of authentication (e.g., fingerprint, voice and/or facial verification on a mobile device or two-factor authentication methods).

In block 203, the social network system checks whether the user login and authentication of 201 was successful; if so, the operations continue to 205. If not, the login/authentication operations are repeated or possibly fail after a number of unsuccessful attempts.

In block 205, the social network system presents to the user an interface that allows the user to enter business-oriented profile information of the user. The profile information can include personal information of the user such as name, contact information, employment information, and employment status information. The profile information can optionally link or otherwise define an active association between the user and one or more companies or groups or other professional or business entities. In embodiments, the active association can be based on full-time employment, part-time employment, contract-based employment, or some other active working relationship between the user and one or more companies or groups or other professional or business entities. In embodiments, the active association can be based on information supplied by the user, the associated company or group, or a combination of the two (e.g., where the company or group or entity verifies the active association with the user. Typically, only a portion of a user's profile may be viewed by the general public and/or by other users. The social network system can also interact with users to enable users to browse and review their profile information and the profile information of other users, communicate with other users via messaging, post content (such as a blog post), identify and establish connections with other users in order to build or reflect relations among users, to recommend business-oriented skills or experiences of other user, and possibly other user actions. Data representing the user profile information, messages, content, connections, recommendations, and other information can be stored by the social network system (e.g., in data storage 120).

The operations of 201 to 205 can be repeated over time to update the business-oriented profile information of the user, including the profile information that links or otherwise defines an active association between the user and one or more companies or groups or entities.

In block 207, the social network system can be configured to present for display to the user a pre-defined list of questions. The social network system can be further configured to elicit responses from the user for each question in the list. The questions and corresponding responses can be used to characterize professional traits of that user as described herein. The number of questions can vary by design. In embodiments, the list of questions can include 40 to 100 or more questions that are specifically adapted to cover a wide range of professional traits of each user as described herein. The social network system can be configured to collect and store response data representing the responses provided by the user for the questions of the list. In other embodiments, the questions and corresponding responses can be used to characterize the professional traits of another user of the social network system who is known to the respondent user (i.e., an observer user providing responses to the questions of the list for characterizing another known user of the system). In embodiments, the observer user(s) can be a friend or colleague of a user of the system. These operations can optionally be repeated over time to update the response data provided by the user.

In block 209, the operations of 201 to 207 can be repeated for additional users of the social network system.

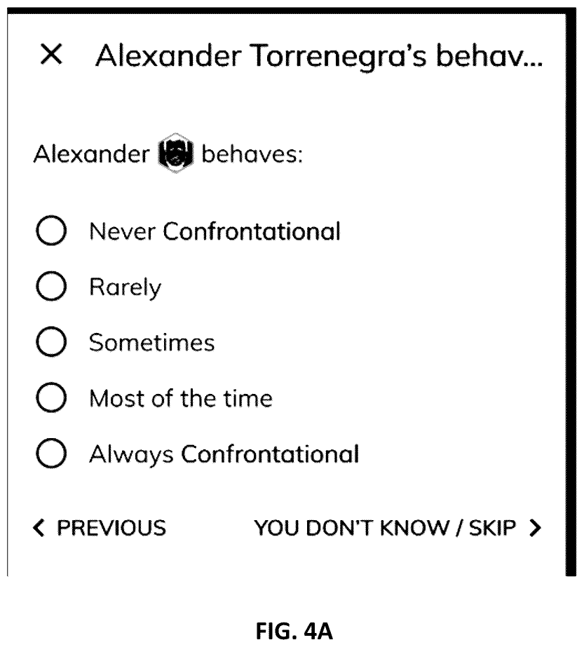

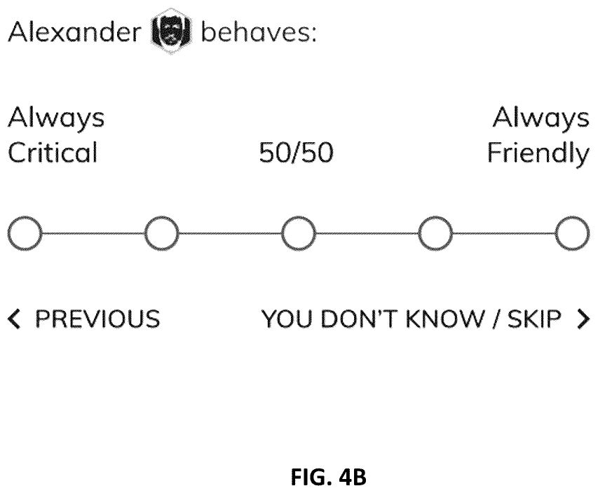

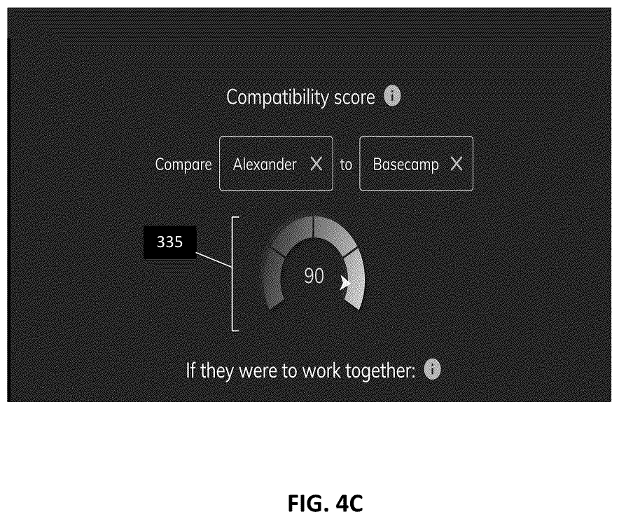

FIG. 4A depicts an example single-trait question that can be presented to evaluate the “confrontational” trait of a user. The system can be configured to store a key-value pair for the question, where the value represents the entered response that characterizes the “confrontational” trait of a user in the integer range of 0-4 to represent the five possible responses. Specifically, more “confrontational” is reflected by more value in the 0-4 score for the single-trait question. In other embodiments, a range that spans positive and negative integer values can be used to represent the possible responses for a single-trait question.

FIG. 4B depicts an example paired-trait question that can be presented to evaluate the paired “critical” and “friendly” traits of a user. The system can be configured to store a key-value pair for the question, where the value represents the entered response that characterizes the spectrum of the critical and friendly traits of the user in the integer range of 0-4 to represent the five possible responses. Specifically, more “critical” is reflected by less value in the 0-4 score for the paired-trait question, and more “friendly” is reflected by more value in the 0-4 score for the paired-trait question. For this exemplary paired-trait question, if you are very critical, you are less friendly. In other embodiments, a range that spans positive and negative integer values can be used to represent the possible responses for a paired-trait question.

FIGS. 3A-3P, collectively, presents a high-level view of another method implemented by the business-oriented social network according to one example implementation.

In block 301, the social network system (and/or user-input) initiates evaluation of business-oriented compatibility between a Source Group and a Target Group. The Source Group can include a particular user or a plurality of users that are actively associated with a company or group or other business or professional entity (e.g., from 205). Similarly, the Target Group can include another particular user or another plurality of users that are actively associated with a different company or group or other business or professional entity (e.g., from 205). Business-oriented compatibility between the Source Group and the Target Group characterizes the natural ability of the Source Group and the Target Group to work together in harmony because of well-matched characteristics and cultural fit.

In block 303a, the social network system identifies one or more users of the system whose profile information defines an active association between such user(s) and the Source Group. The operations of block 207 can optionally be performed for such user(s) to collect or update the response data for such user(s), if desired.

In block 303b, the social network system identifies one or more users of the system whose profile information defines an active association between such user(s) and the Target Group. The operations of block 207 can optionally be performed for such user(s) to collect or update the response data for such user(s), if desired.

In block 305a, the social network system collects (and stores) response data (a list of responses) provided by each user (identified by a corresponding user or member ID) of the Source Group (identified by a corresponding source group ID) to the predefined set of questions (each identified by corresponding question ID) together with each user's weight. The social network system can also collect (and store) response data (a list of responses) provided by observers for the predefined set of questions (each identified by corresponding question ID). Such response data characterizes the personality traits of corresponding individuals or users of the Source Group as perceived by the observer(s) together with each user's weight.

In block 305b, the social network system collects (and stores) response data (a list of responses) provided by each user (identified by a corresponding member or user ID) of the Target Group (identified by a corresponding source group ID) to the predefined set of questions (each identified by corresponding question ID) together with each user's weight. The social network system can also collect (and store) response data (a list of responses) provided by observers for the predefined set of questions (each identified by corresponding question ID). Such response data characterizes the personality traits of corresponding individuals or users of the Target Group as perceived by the observer(s) together with each user's weight.

In block 307, the social network system can be configured to execute a loop over each question in the predefined set of questions. Alternatively, the loop can be configured to execute over questions for which responses of both the Source group and Targe group have been collected and stored. Each iteration of the loop continues from 307 to 329 of FIG. 3D as described below.

In block 309a, the social network system calculates a weighted average of the responses of the users of the Source Group for the question to obtain the $questionWeightedAverage for the question. The weights assigned to the users of the Source Group can be used to bias the calculation of the weighted average in block 309a.

In block 309b, the social network system calculates a weighted average of the responses of the users of Target Group for the question to obtain the $questionWeightedAverage for the question. The weights assigned to the users of the Target Group can be used to bias the calculation of the weighted average in block 309b.

In block 311, the social network system calculates a platform-wise global average $globalMeanforQuestion of the responses for the question across the users of the Platform (from block 207) and a platform-wise standard deviation $globalStdvforQuestion of the responses for the question across the users of the platform (from block 207).

In block 313, the social network system calculates a platform-wise $DeviationFactor for the responses of each question across the users of the platform based on the $globalStdvforQuestion for the question (from block 311). In embodiments, the $DeviationFactor can be calculated as:

$DeviationFactor=1−($globalStdvforQuestion/($globalStdvforQuestion+4)) Eqn. (1)

In block 315a, the social network system calculates a $DifferenceToGlobal parameter for the question with respect to Source Group based on difference between the $questionWeightedAverage for the question (from block 309a) and the $globalMeanforQuestion for the question (from block 311). In embodiments, the $DifferenceToGlobal parameter can be calculated as:

$DifferenceToGlobal=ABS($questionWeightedAverage−$globalMeanforQuestion) Eqn. (2)

In block 315b, the social network system calculates a $DifferenceToGlobal parameter for the question with respect to Target Group based on difference between the $questionWeightedAverage for the question (from block 309b) and the $globalMeanforQuestion for the question. In embodiments, the $DifferenceToGlobal parameter can be calculated according to Eqn. (2) above.

In this manner, the question-specific calculations of blocks 311, 313, 315a and 315b involves statistical analysis that accounts the response data collected from a larger number of users beyond the source group and the target group.

In block 317a, the social network system calculates a relevance factor for the question with respect to the Source Group based on the $DifferenceToGlobal parameter for the question (from block 315a) and the $DeviationFactor for the question (from block 313). In embodiments, the relevance factor for a given question with respect to the Source Group can be calculated as the multiplication product of $DifferenceToGlobal for the question (from block 315a and the $DeviationFactor for the question (from block 313). In embodiments, the relevancy factor for the question with respect to the Source Group can have a value in the range from 0 to 4. The relevance factor for the question with respect to the Source Group can represent a weight that reflects the relative relevance of the question/response from the perspective of the Source Group. In this case, the relevance factor can represent a weight that reflects the amount of separation in the responses of the Source Group relative to the platform-wise global average and deviation values for the question.

In block 317b, the social network system calculates a relevance factor for the question with respect to Target Group based on the $DifferenceToGlobal parameter for the question (from block 315b) and the $DeviationFactor for the question (from block 313). In embodiments, the relevance factor for a given question with respect to the Target Group can be calculated as the multiplication product of $DifferenceToGlobal for the question (from block 315b and the $DeviationFactor for the question (from block 313). In embodiments, the relevancy factor for the question with respect to the Target Group can have a value in the range from 0 to 4. The relevance factor for the question with respect to the Target Group can represent a weight that reflects the relative relevance of the question/response from the perspective of the Target Group. In this case, the relevance factor can represent a weight that reflects the amount of separation in the responses of the Target Group relative to the platform-wise global average and deviation values for the question.

In block 319, the social network system calculates a similarity factor that reflects the similarity (or difference) between the responses of the Source Group and the Target Group for the question.

In block 321a, the social network system calculates an importance factor for the question with respect to the Source Group based on the distribution of the responses for the question in the Source Group. For example, the importance factor can be calculated as:

$ distribution=1/(1+questionStdDev) Eqn. (3a)

$relevance=ABS($questionWeightedAverage−2)/2 Eqn. (3b)

Importance factor=distribution*relevance Eqn. (3c)

In embodiments, the importance factor for the question with respect to the Source Group can have a value in the range from 0 to 4. The importance factor for the question with respect to the Source Group can represent a weight that reflects the relative importance of the question/response from the perspective of the Source Group. In this case, the importance factor for the question with respect to the Source Group can represent a weight that reflects the amount of separation of the responses relative to the group-wise Source Group average and deviation values for the question.

In block 321b, the social network system calculates an importance factor for the question with respect to the Target Group based on the distribution of the responses for the question in the Target Group. For example, the importance factor can be calculated according to Eqns. (3a)-(3c) above. In embodiments, the importance factor for the question with respect to the Target Group can have a value in the range from 0 to 4. The importance factor for the question with respect to the Target Group can represent a weight that reflects the relative importance of the question/response from the perspective of the Target Group. In this case, the importance factor for the question with respect to the Target Group can represent a weight that reflects the amount of separation of the responses relative to the group-wise Target Group average and deviation values for the question.

In block 323a, the social network system uses the importance factor for the Source Group for the question (from block 321a) to adjust the similarity factor (from block 319). For example, the adjusted similarity factor for the Source Group for the question can be calculated as the product of the similarity factor (from block 319) and the importance factor (from block 321a).

In block 323b, the social network system uses the importance factor for the Target Group for the question (from block 321b) to adjust the similarity factor (from block 319). For example, the adjusted similarity factor for the Target Group for the question can be calculated as the product of the similarity factor (from block 319) and the importance factor (from block 321b).

In block 325a, the social network system adds the adjusted similarity factor (from block 323a) to an accumulated source similarity factor accumulated over the predefined list of questions. For example, the accumulated source similarity factor can be calculated as:

SimilarityAccumulateSource+=adjusted similarity factor (from block 325a) Eqn. (4)

In block 325b, the social network system adds the adjusted similarity factor (from block 323b) to an accumulated target similarity factor accumulated over the predefined list of questions. For example, the accumulated target similarity factor can be calculated as:

SimilarityAccumulateTarget+=adjusted similarity factor (from block 325b) Eqn. (5)

In block 327a, the social network system adds the importance factor for the Source Group for the question (from block 321a) to an accumulated source importance factor accumulated over the predefined list of questions. For example, the accumulated source importance factor can be calculated as:

ImportanceAccumulateSource+=importance factor (from block 321a) Eqn. (6)

In block 327b, the social network system adds the importance factor for the Target Group for the question (from block 321a) to an accumulated target importance factor accumulated over the predefined list of questions. For example, the accumulated target importance factor can be calculated as:

ImportanceAccumulateTarget+=importance factor (from block 321b) Eqn. (7)

In block 329, the social network system checks whether the relevant questions in the predefined list of questions have been processed in the loop. If not, the operations revert back to the repeat the loop (via F) for the next loop iteration. If so, the operations continue to block 331.

In block 331, the social network system calculates a weighted score for the Source Group based on the accumulated source similarity factor (from block 325a and based on the questions processed in the loop) and the accumulated source importance factor (from block 327a and based on the questions processed in the loop). This weighted score can represent compatibility between the Source Group and the Target Group from the perspective of the Source Group. It can possibly be used by the system to match and rank compatibility between the Source Group and a number of Target Groups from the perspective of the Source Group. It can possibly be displayed or conveyed in a visual element when presenting the results of this matching and ranking process.

In block 333, the social network system calculates a weighted score for the Target Group based on the accumulated source similarity factor (from block 325b and based on the questions processed in the loop) and the accumulated source importance factor (from block 327b and based on the questions processed in the loop). This weighted score can represent compatibility between the Source Group and the Target Group from the perspective of the Source Group. It can possibly be used by the system to match and rank compatibility between the Source Group and a number of Target Groups from the perspective of the Source Group. It can possibly be displayed or conveyed in a visual element when presenting the results of this matching and ranking process.

In block 335, the social network calculates an overall score by averaging and possibly normalizing the weighted scores of blocks 331 and 333. For example, the overall score can be calculated according to the formula: (score of 7a+score of 7b)/2)*100. This overall score is in the range of 0 to 100 and provides an indication that quantifies the level of compatibility between the Source Group and the Target Group, which characterizes the natural ability of the Source Group and the Target Group to work together in harmony because of well-matched characteristics and cultural fit. FIG. 4 illustrates an exemplary graphical user interface that is generated by the social network system and communicated to a user device for displaying the combined score of block 335 between a particular Source Group (which is an individual user named “Alexander”) and a particular Target Group (which is group or entity named “Basecamp”).

In block 337, the social network system is configured to execute a loop over each question in the predefined set of questions. Alternatively, the loop can be configured to execute over questions for which responses of both the source group and target group have been collected and stored. Each iteration of the loop continues from 337 to 387 of FIG. 3M as described below.

In blocks 339 to 387, the social network system is configured to evaluate the response data for the Source Group and the response data for the Target Group for the question to assign one or more labels to one or more professional traits related to the question where the labels relate to compatibility of the source group and the target group for highlight purposes. For example, the labels can represent categories or classes of traits where the Source Group and the Target Group likely both have a trait as well as different categories or classes of traits where the Source Group and the Target Group likely both do not have a trait. The social network system can be further configured to display one or more traits associated with the respective labels to show i) one or more traits where the Source Group and Target Group likely both have the one more traits, and/or ii) one or more traits where the Source Group and Target Group likely both do not have the one or more traits. In another example, the labels can represent categories or classes of traits where the Source Group likely has a trait and the Target Group likely does not have a trait as well as different categories or classes of traits where the Target Group likely has a trait and the Source Group likely does not have a trait. The social network system can be further configured to display one or more traits associated with the respective labels to show i) one or more traits where the Source Group likely has the one or more traits and the Target Group likely does not have the one or more traits, and/or ii) one or more traits where the Target Group likely has the one or more traits and the Source Group likely does not have the one or more traits. In yet another example, the labels can represent categories or classes of traits where the Source Group would likely influence the Target Group to have more (or less) of the respective traits as well as different categories or classes of traits where the Target Group would likely influence the Source Group to have more (or less) of the respective traits as described below. The social network system can be further configured to display the traits associated with the respective labels to show i) one or more traits where the Source Group would likely influence the Target Group to have more (or less) of the one or more traits, and/or ii) one or more traits where the Target Group would likely influence the Source Group to have more (or less) of the one or more traits.

In block 339, the social network system evaluates the response data for the Source Group and the Target Group for the question and the relative difference therebetween to determine if the response data satisfies a predetermined criterion for the “Different-Source-Has” label. In embodiments, the predetermined criterion for the “Different-Source-Has” label is configured to establish that the Source Group has the professional trait corresponding to the question and that the Target Group does not have the professional trait corresponding to the question. The criterion can include one or more conditions that establish that the Source Group has the professional trait corresponding to the question and the Target Group does not have the professional trait corresponding to the question. In embodiments, such condition(s) can be based on statistical parameters (such as mean response and/or standard deviation) derived from the response data collected from the user(s) or observers of the Source Group or the Target Group for the particular question, one or more threshold parameters (which can be shared across questions or specific to one or more questions), and statistical parameters (such as mean response and/or standard deviation) derived from responses collected from all users or observers for the particular question. In embodiments, the threshold parameter(s) for the questions can be set by the designer of the system.

In block 341, the social network system checks whether the predetermined criterion for the “Different-Source-Has” label is satisfied. If so, the operations continue to blocks 343a and 343b and then to block 345. Otherwise, the operations continue to block 345.

In block 343a, the social network system adds the question ID or trait ID for the question to a list of “Different-Source-Has” questions or traits from the perspective of the Source Group, normalizes the difference (from block 339) based on the relevance factor for the question with respect to Source Group (from block 317a) and possibly a relevant threshold value, and associates the resultant normalized value with the question ID or trait ID in the list for ranking the question or trait relative to other “Different-Source-Has” questions or traits from the perspective of the Source Group.

In block 343b, the social network system adds the question ID or trait ID for the question to a list of “Different-Source-Has” questions or traits from the perspective of the Target Group, normalizes the difference (from block 339) based on the relevance factor for the question with respect to Target Group (from block 317b) and possibly a relevant threshold value, and associates the resultant normalized value with the question ID or trait ID in the list for ranking the question or trait relative to other “Different-Source-Has” questions or traits from the perspective of the Target Group.

For paired-trait questions, similar operations to those of blocks 339 to 343b can be performed to process the response data for the question to determine whether the Source Group has the opposite paired trait corresponding to the question and the Target Group does not have the opposite paired trait corresponding to the question, and to record such results in the appropriate list and ranked as described in block 343a and 343b.

In block 345, the social network system evaluates the response data for the Source Group and the Target Group for the question and the relative difference therebetween to determine if the response data satisfies a predetermined criterion for the “Different-Target-Has” label. In embodiments, the predetermined criterion for the “Different-Target-Has” label is configured to establish that the Target Group has the professional trait corresponding to the question and that the Source Group does not have the professional trait corresponding to the question. The criterion can include one or more conditions that establish that the Target Group has the professional trait corresponding to the question and the Source Group does not have the professional trait corresponding to the question. In embodiments, such condition(s) can be based on statistical parameters (such as mean response and/or standard deviation) derived from the response data collected from the user(s) or observers of the Source Group or the Target Group for the particular question, one or more threshold parameters (which can be shared across questions or specific to one or more questions), and statistical parameters (such as mean response and/or standard deviation) derived from responses collected from all users or observers for the particular question. In embodiments, the threshold parameter(s) can be set by the designer of the system.

In block 347, the social network system checks whether the predetermined criterion for the “Different-Target-Has” label is satisfied. If so, the operations continue to blocks 349a and 349b and then to block 351. Otherwise, the operations continue to block 351.

In block 349a, the social network system adds the question ID or trait ID for the question to a list of “Different-Target-Has” questions or traits from the perspective of the Source Group, normalizes the difference (from block 345) based on the relevance factor for the question with respect to Source Group (from block 317a) and possibly a relevant threshold value, and associates the resultant normalized value with the question ID or trait ID in the list for ranking the question or trait relative to other “Different-Target-Has” questions or traits from the perspective of the Source Group.

In block 349b, the social network system adds the question ID or trait ID for the question to a list of “Different-Target-Has” questions or traits from the perspective of the Target Group, normalizes the difference (from block 345) based on the relevance factor for the question with respect to Target Group (from block 317b) and possibly a relevant threshold value, and associates the resultant normalized value with the question ID or trait ID in the list for ranking the question or trait relative to other “Different-Target-Has” questions or traits from the perspective of the Target Group.

For paired-trait questions, similar operations to those of blocks 345 to 349b can be performed to process the response data for the question to determine whether the Target Group has the opposite paired trait corresponding to the question and the Source Group does not have the opposite paired trait corresponding to the question, and to record such results in the appropriate list and ranked as described in block 349a and 349b.

In block 351, the social network system evaluates the response data for the Source Group and the Target Group for the question and the relative difference therebetween to determine if the response data satisfies a predetermined criterion for the “Similar-Have” label. In embodiments, the predetermined criterion for the “Similar-Have” label is configured to establish that both the Source Group and the Target Group have the professional trait corresponding to the question. The criterion can include one or more conditions that establish that both the Source Group and the Target Group have the professional trait corresponding to the question. In embodiments, such condition(s) can be based on statistical parameters (such as mean response and/or standard deviation) derived from the response data collected from the user(s) or observers of the Source Group or the Target Group for the particular question, one or more threshold parameters (which can be shared across questions or specific to one or more questions), and statistical parameters (such as mean response and/or standard deviation) derived from responses collected from all users or observers for the particular question. In embodiments, the threshold parameter(s) can be set by the designer of the system.

In block 353, the social network system checks whether the predetermined criterion for the “Similar-Have” label is satisfied. If so, the operations continue to blocks 355a and 355b and then to block 357. Otherwise, the operations continue to block 357.

In block 355a, the social network system adds the question ID or trait ID for the question to a list of “Similar-Have” questions or traits from the perspective of the Source Group, normalizes the difference (from block 351) based on the relevance factor for the question with respect to Source Group (from block 317a) and possibly a relevant threshold value, and associates the resultant normalized value with the question ID or trait ID in the list for ranking the question or trait relative to other “Similar-Have” questions or traits from the perspective of the Source Group.

In block 355b, the social network system adds the question ID or trait ID for the question to a list of “Similar-Have” questions or traits from the perspective of the Target Group, normalizes the difference (from block 351) based on the relevance factor for the question with respect to Target Group (from block 317b) and possibly a relevant threshold value, and associates the resultant normalized value with the question ID or trait ID in the list for ranking the question relative to other “Similar-Have” questions or traits from the perspective of the Target Group.

For paired-trait questions, similar operations to those of blocks 351 to 355b can be performed to process the response data for the question to determine whether both the Source Group and the Target Group have the opposite paired trait corresponding to the question, and to record such results in the appropriate list and ranked as described in block 355a and 355b.

In block 357, the social network system evaluates the response data for the Source Group and the Target Group for the question and the relative difference therebetween to determine if the response data satisfies a predetermined criterion for the “Similar-Don't-Have” label. In embodiments, the predetermined criterion for the “Similar-Don't-Have” label is configured to establish that both the Source Group and the Target Group do not have the professional trait corresponding to the question. The criterion can include one or more conditions that establish that both the Source Group and the Target Group do not have the professional trait corresponding to the question. In embodiments, such condition(s) can be based on statistical parameters (such as mean response and/or standard deviation) derived from the response data collected from the user(s) or observers of the Source Group or the Target Group for the particular question, one or more threshold parameters (which can be shared across questions or specific to one or more questions), and statistical parameters (such as mean response and/or standard deviation) derived from responses collected from all users or observers for the particular question. In embodiments, the threshold parameter(s) can be set by the designer of the system.

In block 359, the social network system checks whether the predetermined criterion for the “Similar-Don't-Have” label is satisfied. If so, the operations continue to blocks 361a and 361b and then to block 363. Otherwise, the operations continue to block 363.

In block 361a, the social network system adds the question ID or trait ID for the question to a list of “Similar-Don't-Have” questions or traits from the perspective of the Source Group, normalizes the difference (from block 357) based on the relevance factor for the question with respect to Source Group (from block 317a) and possibly a relevant threshold value, and associates the resultant normalized value with the question ID or trait ID in the list for ranking the question or trait relative to other “Similar-Don't-Have” questions or traits from the perspective of the Source Group.

In block 361b, the social network system adds the question ID or trait ID for the question to a list of “Similar-Don't-Have” questions from the perspective of the Target Group, normalizes a value from block 357 (e.g., the value of the second variable) based on the relevance factor for the question with respect to Target Group (from block 317b) and possibly a relevant threshold value, and associates the resultant normalized value with the question ID or trait ID in the list for ranking the question or trait relative to other “Similar-Don't-Have” questions or traits from the perspective of the Target Group.

For paired-trait questions, similar operations to those of blocks 357 to 361b can be performed to process the response data for the question to determine whether both the Source Group and the Target Group do not have the opposite paired trait corresponding to the question, and to record such results in the appropriate list and ranked as described in block 361a and 361b.

In block 363, the social network system evaluates the response data for the Source Group and the Target Group for the question to determine if the response data satisfies a predefined criterion to establish that the Source Group would likely influence the Target Group to have more of the professional trait corresponding to the question (or “Source-More-Influence-Target” label). The criterion can include one or more conditions that establish that the Source Group would likely influence the Target Group to have more of the professional trait corresponding to the question. In embodiments, such condition(s) can be based on a first variable that accounts for the difference between the response data for the Target Group as provided by the user(s) of the Target Group and the response data for the Target Group as provided by observer(s) of the Target Group. Note that the response data for the Target Group as provided by the observer(s) of the Target Group characterizes the way others perceive the Target Group. Such difference can be normalized by global statistics for the question (such as the standard deviation of the question) as follows:

first variable=ABS(mean response data from Target Group users−mean response data from Target Group observers)/global-standard-deviation Eqn. (8)

This condition can be configured to ensure that the differences between the response data for the Target Group as provided by the user(s) of the Target Group and the response data for the Target Group as provided by observer(s) of the Target Group are sufficiently large that the Target Group can be influenced by the Source Group (whether the influence be for more or less of the corresponding trait). The condition(s) can also be based on a second variable that accounts for the difference between the response data for the Target Group as provided by the user(s) of the Target Group and the response data for the Source Group as provided by the users of the Source Group as follows:

second variable=ABS(mean or weighted average of the response data from Target Group users−mean or weighted average of the response data from Source Group users) Eqn. (9)

This condition can be configured to ensure that the differences between the response data for the Target Group as provided by the user(s) of the Target Group and the response data for the Source Group as provided by user(s) of the Source Group is sufficiently small that the Target Group will likely be influenced by the Source Group (whether the influence will likely be for more or less of the corresponding trait). The condition(s) can also be based on one or more additional variables that account for the difference between the response data for the Target Group as provided by the user(s) of the Target Group and the response data for the Target Group as provided by the observers of the Target Group and/or the difference between the response data for the Target Group as provided by the user(s) of the Target Group and the response data for the Source Group as provided by the users of the Source Group. Such additional variable(s) can be configured to establish that the Source Group would likely influence the Target Group to have more of the professional trait corresponding to the question. In this manner, conditions that establish that the Source Group would likely influence the Target Group to have more of the professional trait corresponding to the question can be satisfied when the first variable is greater than (or possibly equal to) a predefined threshold level and the second variable is less than (or possibly equal to) the same predefined threshold level (or another predefined threshold level) and the one more additional variables is (are) less than zero. For paired-trait questions, these same conditions can be evaluated to establish that the Source Group would likely influence the Target Group to have more of one of the paired professional traits corresponding to the question, (e.g., the “Friendly” trait of FIG. 4B), and likely influence the Target Group to have less of the opposite paired professional trait corresponding to the question (e.g., the “Critical” trait of FIG. 4B).

In block 365, the social network system checks whether the predetermined criterion for the “Source-More-Influence-Target” label is satisfied. If so, the operations continue to blocks 367a and 367b and then to block 369. Otherwise, the operations continue to block 369.

In block 367a, the social network system adds the question ID or trait ID for the question to a list of “Source-More-Influence-Target” questions or traits from the perspective of the Source Group, normalizes a value from block 363 (e.g., the value of the second variable) based on the relevance factor for the question with respect to Source Group (from block 317a) and possibly other statistical parameters, and associates the resultant normalized value with the question ID or trait ID in the list for ranking the question/trait relative to other “Source-More-Influence-Target” questions/traits from the perspective of the Source Group. For paired-trait questions, the trait ID for the opposite paired trait of the question can be added to the list of “Source-Less-Influence-Target” traits from the perspective of the Source Group and ranked as described below in block 373a.

In block 367b, the social network system adds the question ID or trait ID for the question to a list of “Source-More-Influence-Target” questions or traits from the perspective of the Target Group, normalizes a value from block 363 (e.g., the value of the second variable) based on the relevance factor for the question with respect to Target Group (from block 317b) and possibly other statistical parameters, and associates the resultant normalized value with the question ID or trait ID in the list for ranking the question or trait relative to other “Source-Have-Influence-Target” questions or traits from the perspective of the Target Group. For paired-trait questions, the trait ID for the opposite paired trait of the question can be added to the list of “Source-Less-Influence-Target” traits from the perspective of the Target Group and ranked as described below in block 373b.

In block 369, the social network system evaluates the response data for the Source Group and the Target Group for the question to determine if the response data satisfies a predefined criterion to establish that the Source Group would likely influence the Target Group to have less of the professional trait corresponding to the question (or “Source-Less-Influence-Target” label). The criterion can include one or more conditions that establish that the Source Group would likely influence the Target Group to have less of the professional trait corresponding to the question. In embodiments, such condition(s) can be based on i) the first variable that accounts for the difference between the response data for the Target Group as provided by the user(s) of the Target Group and the response data for the Target Group as provided by observer(s) of the Target Group, with the difference normalized by global statistics for the question (such as the standard deviation of the question) of Eqn. (8) above, ii) the second variable that accounts for the difference between the response data for the Target Group as provided by the user(s) of the Target Group and the response data for the Source Group as provided by the users of the Source Group of Eqn. (9) above, and iii) the one or more additional variables that account for the difference between the response data for the Target Group as provided by the user(s) of the Target Group and the response data for the Target Group as provided by the observers of the Target Group and/or the difference between the response data for the Target Group as provided by the user(s) of the Target Group and the response data for the Source Group as provided by the users of the Source Group. Such additional variable(s) can be configured to establish that the Source Group would likely influence the Target Group to have less of the professional trait corresponding to the question. In this manner, conditions that establish that the Source Group would likely influence the Target Group to have less of the professional trait corresponding to the question can be satisfied when the first variable is greater than (or possibly equal to) a predefined threshold level and the second variable is less than (or possibly equal to) the same predefined threshold level (or another predefined threshold level), and the one or more additional variables is (are) greater than zero. For paired-trait questions, these same conditions can be evaluated to establish that the Source Group would likely influence the Target Group to have less of one of the paired professional traits corresponding to the question, (e.g., the “Friendly” trait of FIG. 4B), and likely influence the Target Group to have more of the opposite paired trait corresponding to the question (e.g., the “Critical” trait of FIG. 4B).

In block 371, the social network system checks whether the predetermined criterion for the “Source-Less-Influence-Target” label is satisfied. If so, the operations continue to blocks 373a and 373b and then to block 375. Otherwise, the operations continue to block 375.

In block 373a, the social network system adds the question ID or trait ID for the question to a list of “Source-Less-Influence-Target” questions or traits from the perspective of the Source Group, normalizes a value from block 369 (e.g., the value of the second variable) based on the relevance factor for the question with respect to Source Group (from block 317a) and possibly other statistical parameters, and associates the resultant normalized value with the question ID or trait ID in the list for ranking the question or trait relative to other “Source-Less-Influence-Target” questions or traits from the perspective of the Source Group. For paired-trait questions, the trait ID for the opposite paired trait of the question can be added to the list of “Source-More-Influence-Target” traits from the perspective of the Source Group and ranked as described below in block 367a.

In block 373b, the social network system adds the question ID or trait ID for the question to a list of “Source-Less-Influence-Target” questions or traits from the perspective of the Target Group, normalizes a value from block 369 (e.g., the value of the second variable) based on the relevance factor for the question with respect to Target Group (from block 317b) and possibly other statistical parameters, and associates the resultant normalized value with the question ID or trait ID in the list for ranking the question or trait relative to other “Source-Less-Influence-Target” questions from the perspective of the Target Group. For paired-trait questions, the trait ID for the opposite paired trait of the question can be added to the list of “Source-More-Influence-Target” traits from the perspective of the Target Group and ranked as described below in block 367b.

In block 375, the social network system evaluates the response data for the Source Group and the Target Group for the question to determine if the response data satisfies a predefined criterion to establish that the Target Group would likely influence the Source Group to have more of the professional trait corresponding to the question (or “Target-More-Influence-Source” label). The criterion can include one or more conditions that establish that the Target Group would likely influence the Source Group to have more of the professional trait corresponding to the question. In embodiments, such condition(s) can be based on a first variable that accounts for the difference between the response data for the Source Group as provided by the user(s) of the Source Group and the response data for the Source Group as provided by observer(s) of the Source Group. Note that the response data for the Source Group as provided by observer(s) of the Source Group characterizes the way others perceive the Source Group. Such difference can be normalized by global statistics for the question (such as the standard deviation of the question) as follows:

first variable=ABS(mean response data from Source Group users−mean response data from Source Group observers)/global-standard-deviation Eqn. (10)

This condition can be configured to ensure that the differences between the response data for the Source Group as provided by the user(s) of the Source Group and the response data for the Source Group as provided by observer(s) of the Source Group are sufficiently large that the Source Group can be influenced by the Target Group (whether the influence be for more or less of the corresponding trait). The condition(s) can also be based on a second variable that accounts for the difference between the response data for the Source Group as provided by the user(s) of the Source Group and the response data for the Target Group as provided by the users of the Target Group as follows:

second variable=ABS(mean or weighted average of the response data from Source Group users−mean or weighted average of the response data from Target Group users) Eqn. (11)

This condition can be configured to ensure that the differences between the response data for the Source Group as provided by the user(s) of the Source Group and the response data for the Target Group as provided by user(s) of the Target Group is sufficiently small that the Source Group will likely be influenced by the Target Group (whether the influence will likely be for more or less of the corresponding trait). The condition(s) can also be based on one or more additional variables that account for the difference between the response data for the Source Group as provided by the user(s) of the Source Group and the response data for the Source Group as provided by the observers of the Source Group and/or the difference between the response data for the Source Group as provided by the user(s) of the Source Group and the response data for the Target Group as provided by the users of the Target Group. Such additional variable(s) can be configured to establish that the Target Group would likely influence the Source Group to have more of the professional trait corresponding to the question. In this manner, conditions that establish that the Target Group would likely influence the Source Group to have more of the professional trait corresponding to the question can be satisfied when the first variable is greater than (or possibly equal to) a predefined threshold level and the second variable is greater than (or possibly equal to) the same predefined threshold level (or another predefined threshold level) and the one more additional variables is (are) less than zero. For paired-trait questions, these same conditions can be evaluated to establish that the Target Group would likely influence the Source Group to have more of one of the paired professional traits corresponding to the question, (e.g., the “Friendly” trait of FIG. 4B), and likely influence the Source Group to have less of the opposite paired trait corresponding to the question (e.g., the “Critical” trait of FIG. 4B).

In block 377, the social network system checks whether the predetermined criterion for the “Target-More-Influence-Source” label is satisfied. If so, the operations continue to blocks 379a and 379b and then to block 381. Otherwise, the operations continue to block 381.

In block 379a, the social network system adds the question ID or trait ID for the question to a list of “Target-More-Influence-Source” questions or traits from the perspective of the Source Group, normalizes a value from block 375 (e.g., the value of the second variable) based on the relevance factor for the question with respect to Source Group (from block 317a) and possibly other statistical parameters, and associates the resultant normalized value with the question ID in the list for ranking the question or trait relative to other “Target-More-Influence-Source” questions or traits from the perspective of the Source Group. For paired-trait questions, the trait ID for the opposite paired trait of the question can be added to the list of “Target-Less-Influence-Source” traits from the perspective of the Source Group and ranked as described below in block 385a.

In block 379b, the social network system adds the question ID or trait ID for the question to a list of “Target-More-Influence-Source” questions or traits from the perspective of the Target Group, normalizes a value from block 375 (e.g., the value of the second variable) based on the relevance factor for the question with respect to Target Group (from block 317b) and possibly other statistical parameters, and associates the resultant normalized value with the question ID in the list for ranking the question relative to other “Target-More-Influence-Source” questions or traits from the perspective of the Target Group. For paired-trait questions, the trait ID for the opposite paired trait of the question can be added to the list of “Target-Less-Influence-Source” traits from the perspective of the Target Group and ranked as described below in block 385b.

In block 381, the social network system evaluates the response data for the Source Group and the Target Group for the question to determine if the response data satisfies a predefined criterion to establish that the Target Group would likely influence the Source Group to have less of the professional trait corresponding to the question (or “Target-Less-Influence-Source” label). The criterion can include one or more conditions that establish that the Target Group would likely influence the Source Group to have less of the professional trait corresponding to the question. In embodiments, such condition(s) can be based on the first variable that accounts for the difference between the response data for the Source Group as provided by the user(s) of the Source Group and the response data for the Source Group as provided by observer(s) of the Source Group, with the difference normalized by global statistics for the question (such as the standard deviation of the question) of Eqn. (10) above, the second variable that accounts for the difference between the response data for the Source Group as provided by the user(s) of the Source Group and the response data for the Target Group as provided by the users of the Target Group of Eqn. (11) above, and the one or more additional variables that account for the difference between the response data for the Source Group as provided by the user(s) of the Source Group and the response data for the Source Group as provided by the observers of the Source Group and/or the difference between the response data for the Source Group as provided by the user(s) of the Source Group and the response data for the Target Group as provided by the users of the Target Group. Such additional parameter(s) can be configured to establish that the Target Group would likely influence the Source Group to have less of the professional trait corresponding to the question. In this manner, conditions that establish that the Target Group would likely influence the Source Group to have less of the professional trait corresponding to the question can be satisfied when the first variable is greater than (or possibly equal to) a predefined threshold level and the second variable is less than (or possibly equal to) the same predefined threshold level (or another predefined threshold level), and the one or more additional variables is (are) greater than zero. For paired-trait questions, these same conditions can be evaluated to establish that the Target Group would likely influence the Source Group to have less of one of the paired professional traits corresponding to the question, (e.g., the “Friendly” trait of FIG. 4B), and likely influence the Source Group to have more of the opposite paired trait corresponding to the question (e.g., the “Critical” trait of FIG. 4B).

In block 383, the social network system checks whether the predetermined criterion for the “Target-Less-Influence-Source” label is satisfied. If so, the operations continue to blocks 385a and 385b and then to block 387. Otherwise, the operations continue to block 387.

In block 385a, the social network system adds the question ID or trait ID for the question to a list of “Target-Less-Influence-Source” questions from the perspective of the Source Group, normalizes a value from block 381 (e.g., the value of the second variable) based on the relevance factor for the question with respect to Source Group (from block 317a) and possibly other statistical parameters, and associates the resultant normalized value with the question ID or trait IS in the list for ranking the question or trait relative to other “Target-Less-Influence-Source” questions or traits from the perspective of the Source Group. For paired-trait questions, the trait ID for the opposite paired trait of the question can be added to the list of “Target-More-Influence-Source” traits from the perspective of the Source Group and ranked as described below in block 379a.

In block 385b, the social network system adds the question ID or trait ID for the question to a list of “Target-Less-Influence-Source” questions from the perspective of the Target Group, normalizes a value from block 381 (e.g., the value of the second variable) based on the relevance factor for the question with respect to Target Group (from block 317b) and possibly other statistical parameters, and associates the resultant normalized value with the question ID or trait ID in the list for ranking the question or trait relative to other “Target-Less-Influence-Source” questions from the perspective of the Target Group. For paired-trait questions, the trait ID for the opposite paired trait of the question can be added to the list of “Target-More-Influence-Source” traits from the perspective of the Target Group and ranked as described below in block 379b.

In block 387, the social network system checks whether all of the relevant questions in the predefine list of questions have been processed in the loop. If not, the operations can revert back to the repeat the loop (via Q) for the next loop iteration. If so, the operations continue to perform some or all of the display operations of blocks 389a to 401b as follows.

In block 389a, the social network system presents for display one or more professional traits corresponding to the list of “Different-Source-Has” questions or traits from the perspective of the Source Group in a ranked order (e.g., from more importance to less importance) based on the ranking of 343a.

In block 391a, the social network system presents for display one or more professional traits corresponding to the list of “Different-Target-Has” questions or traits from the perspective of the Source Group in a ranked order (e.g., from more importance to less importance) based on the ranking of 349a.

In block 393a, the social network system presents for display one or more professional traits corresponding to the list of “Similar-Have” questions or traits from the perspective of the Source Group in a ranked order (e.g., from more importance to less importance) based on the ranking of 355a.

In block 395a, the social network system presents for display one or more professional traits corresponding to the list of “Similar-Don't-Have” questions or traits from the perspective of the Source Group in a ranked order (e.g., from more importance to less importance) based on the ranking of 361a.

In block 397a, the social network system presents for display one or more professional traits corresponding to the list of “Source-More-Influence-Target” questions or traits from the perspective of the Source Group in a ranked order (e.g., from more importance to less importance) based on the ranking of 367a.

In block 399a, the social network system presents for display one or more professional traits corresponding to the list of “Source-Less-Influence-Target” questions or traits from the perspective of the Source Group in a ranked order (e.g., from more importance to less importance) based on the ranking of 373a.

In block 401a, the social network system presents for display one or more professional traits corresponding to the list of “Target-More-Influence-Source” questions or traits from the perspective of the Source Group in a ranked order (e.g., from more importance to less importance) based on the ranking of 379a.

In block 403a, the social network system presents for display one or more professional traits corresponding to the list of “Target-Less-Influence-Source” questions or traits from the perspective of the Source Group in a ranked order (e.g., from more importance to less importance) based on the ranking of 385a.

The professional traits displayed in blocks 389a to 403a can be associated with text labels that convey the meaning of the respective groupings or classes of professional traits.

In block 389b, the social network system presents for display one or more professional traits corresponding to the list of “Different-Source-Has” questions or traits from the perspective of the Target Group in a ranked order (e.g., from more importance to less importance) based on the ranking of 343b.

In block 391b, the social network system presents for display one or more professional traits corresponding to the list of “Different-Target-Has” questions or traits from the perspective of the Target Group in a ranked order (e.g., from more importance to less importance) based on the ranking of 349b.

In block 393b, the social network system presents for display one or more professional traits corresponding to the list of “Similar-Have” questions or traits from the perspective of the Target Group in a ranked order (e.g., from more importance to less importance) based on the ranking of 355b.

In block 395b, the social network system presents for display one or more professional traits corresponding to the list of “Similar-Don't-Have” questions or traits from the perspective of the Target Group in a ranked order (e.g., from more importance to less importance) based on the ranking of 361b.

In block 397b, the social network system presents for display one or more professional traits corresponding to the list of “Source-More-Influence-Target” questions or traits from the perspective of the Target Group in a ranked order (e.g., from more importance to less importance) based on the ranking of 367b.

In block 399b, the social network system presents for display one or more professional traits corresponding to the list of “Source-Less-Influence-Target” questions or traits from the perspective of the Target Group in a ranked order (e.g., from more importance to less importance) based on the ranking of 373b.

In block 401b, the social network system presents for display one or more professional traits corresponding to the list of “Target-More-Influence-Source” questions or traits from the perspective of the Target Group in a ranked order (e.g., from more importance to less importance) based on the ranking of 379b.

In block 403b, the social network system presents for display one or more professional traits corresponding to the list of “Target-Less-Influence-Source” questions or traits from the perspective of the Target Group in a ranked order (e.g., from more importance to less importance) based on the ranking of 385b.

The professional traits displayed in blocks 389b to 403b can be associated with text labels that convey the meaning of the respective groupings or classes of professional traits.

In optional block 405, the social network system presents for display the distributions of responses for the Source Group together with the distributions of the responses for the Target Group for questions corresponding to specific professional traits for comparison purposes.

In block 407, the social network system can repeat certain operations of the process from 301 to 405 for the same Source Group and a number of different Target Groups in order to evaluate business-oriented compatibility between the Source group and the Different target groups from the perspective of the source group; the scores corresponding to each Source Group-Target group pair can be used to evaluate, match and rank the business-oriented compatibility between the Source Group and the different Target Groups from the perspective of the Source Group.

In optional block 409, optionally, the social network system can repeat certain operations of the process from 301 to 405 for the same Target group and a number of different Source Groups in order to evaluate business-oriented compatibility between the Target Group and the different Source Groups from the perspective of the Target Group. The scores corresponding to each Source Group-Target Group pair can be used to evaluate, match, and rank the business-oriented compatibility between the Target group and the different Source Groups from the perspective of the Target Group.

FIG. 4C illustrates an exemplary graphical user interface that is generated by the social network system and communicated to a user device for displaying the score of block 335 between a particular Source Group (which is an individual user named “Alexander”) and a particular Target Group (which is group or entity named “Basecamp”).

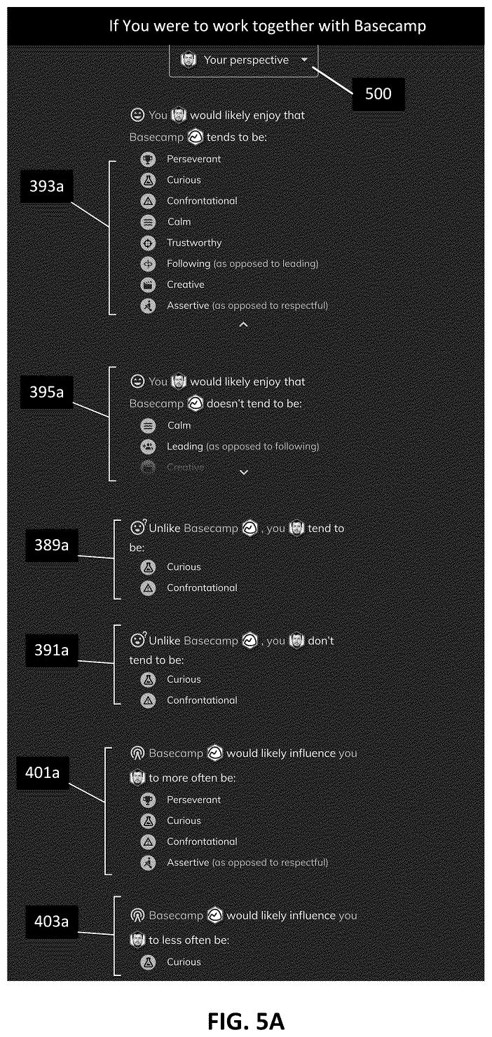

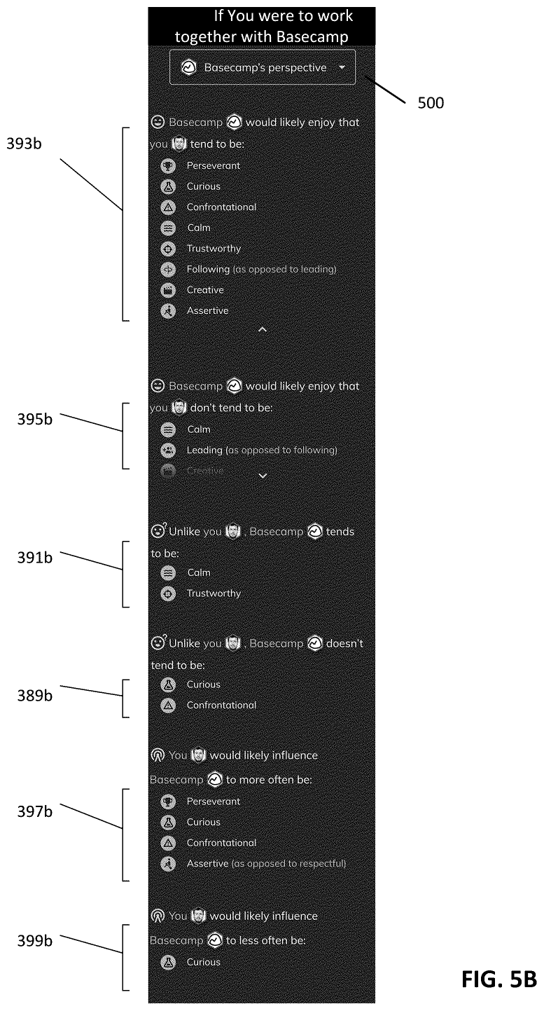

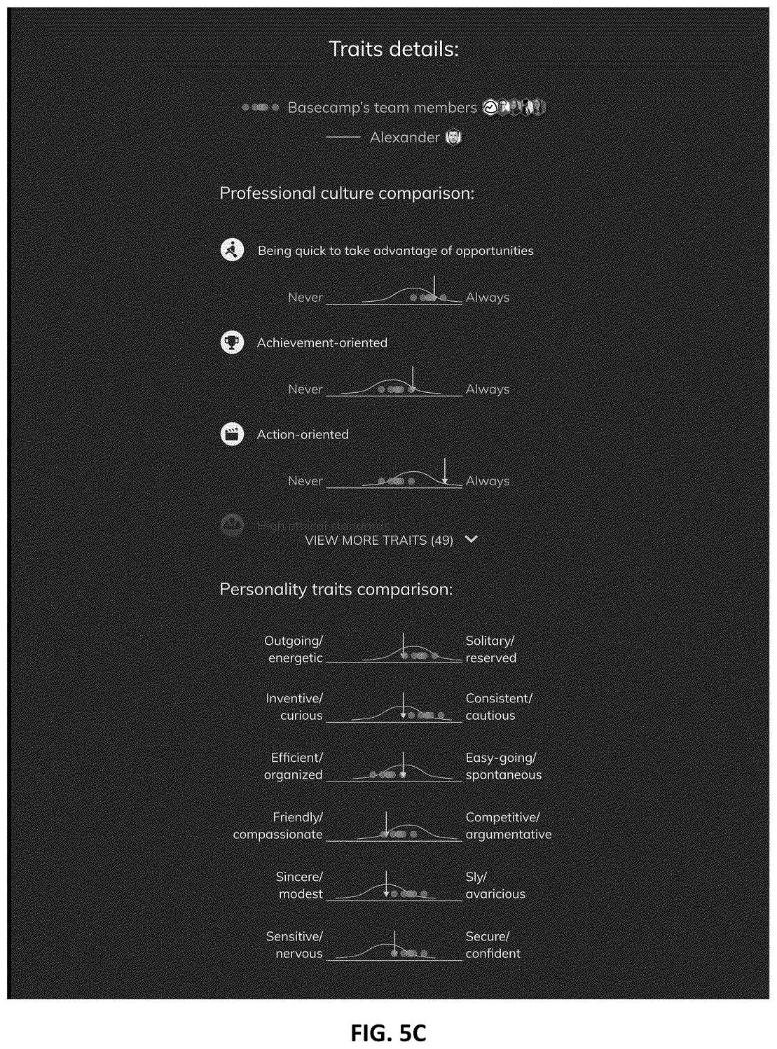

FIG. 5A illustrates an exemplary graphical user interface that is generated by the social network system and communicated to a user device for displaying the groupings of professional traits (or portion thereof) that characterize the compatibility of a particular Source Group (which is an individual user named “Alexander”) and a particular Target Group (named “Base Camp”) from the perspective of the Source Group (“Alexander”) according to the operations of FIGS. 3A-3P.

FIG. 5B illustrates an exemplary graphical user interface that is generated by the social network system and communicated to a user device for displaying the groupings of professional traits (or portion thereof) that characterize the compatibility of the particular Source Group (which is an individual user named “Alexander”) and a particular Target Group (named “Base Camp) from the perspective of the Target Group (“Base Camp”) according to the operations of FIGS. 3A-3P.

In the interfaces of FIGS. 5A and 5B, the user can toggle between the interface of FIGS. 5A and 5B using the selector widget 500 as shown.

The interface of FIG. 5A displays a number of professional traits corresponding to the list of “Similar-Have” questions or traits from the perspective of the Source Group in a ranked order (e.g., from more importance to less importance) based on the ranking of 355a as determined in block 393. These professional traits are associated with the label “You will likely enjoy that Base Camp tends to be:” as shown.

The interface of FIG. 5A also displays a number of professional traits corresponding to the list of “Similar-Don't-Have” questions or traits from the perspective of the Source Group in a ranked order (e.g., from more importance to less importance) based on the ranking of 361a as determined in block 395a. These professional traits are associated with the label “You will likely enjoy that Base Camp doesn't tend to be:” as shown.

The interface of FIG. 5A also displays a number of professional traits corresponding to the list “Different-Source-Has” questions or traits from the perspective of the Source Group in a ranked order (e.g., from more importance to less importance) based on the ranking of 343a as determined in block 389a. These professional traits are associated with the label “Unlike Basecamp, you tend to be:” as shown.

The interface of FIG. 5A also displays a number of professional traits corresponding to the list “Different-Target-Has” questions or traits from the perspective of the Source Group in a ranked order (e.g., from more importance to less importance) based on the ranking of 349a as determined in block 391a. These professional traits are associated with the label “Unlike Basecamp, you don't tend to be:” as shown.

The interface of FIG. 5A also displays a number of professional traits corresponding to the list of “Target-More-Influence-Source” questions or traits from the perspective of the Source Group in a ranked order (e.g., from more importance to less importance) based on the ranking of 379a as determined in block 401a. These professional traits are associated with the label “Basecamp would likely influence you to more often be:” as shown.

The interface of FIG. 5A also displays a number of professional traits corresponding to the list of “Target-Less-Influence-Source” questions or traits from the perspective of the Source Group in a ranked order (e.g., from more importance to less importance) based on the ranking of 385a as determined in block 403a. These professional traits are associated with the label “Basecamp would likely influence you to less often be:” as shown.

The interface of FIG. 5B displays a number of professional corresponding to the list of “Similar-Have” questions or traits from the perspective of the Target Group in a ranked order (e.g., from more importance to less importance) based on the ranking of 355b as determined in block 393b. These professional traits are associated with the label “Basecamp would likely enjoy that you tend to be:” as shown.

The interface of FIG. 5B also displays a number of professional traits corresponding to the list of “Similar-Don't-Have” questions or traits from the perspective of the Target Group in a ranked order (e.g., from more importance to less importance) based on the ranking of 361b as determined in block 395b. These professional traits are associated with the label “Basecamp would likely enjoy that you don't tend to be:” as shown.

The interface of FIG. 5B also displays a number of professional traits corresponding to the list of “Different-Target-Has” questions or traits from the perspective of the Target Group in a ranked order (e.g., from more importance to less importance) based on the ranking of 349b as determined in block 391b. These professional traits are associated with the label “Unlike you, Basecamp tends to be:” as shown.

The interface of FIG. 5B also displays a number of professional traits corresponding to the list of “Different-Source-Has” questions or traits from the perspective of the Target Group in a ranked order (e.g., from more importance to less importance) based on the ranking of 343b as determined in block 389b. These professional traits are associated with the label “Unlike you, Basecamp doesn't tend to be:” as shown.

The interface of FIG. 5B also displays a number of professional traits corresponding to the list of “Source-More-Influence-Target” questions or traits from the perspective of the Target Group in a ranked order (e.g., from more importance to less importance) based on the ranking of 367b as determined in block 397b. These professional traits are associated with the label “You would likely influence Basecamp to more often be:” as shown.

The interface of FIG. 5B also displays a number of professional traits corresponding to the list of “Source-Less-Influence-Target” questions or traits from the perspective of the Target Group in a ranked order (e.g., from more importance to less importance) based on the ranking of 373b as determined in block 399b. These professional traits are associated with the label “You would likely influence Basecamp to less often be:” as shown.

FIG. 5C illustrates an exemplary graphical user interface that is generated by the social network system and communicated to a user device for displaying the distributions of responses for the Source Group together with the distributions of the responses for the Target Group for questions corresponding to specific professional traits for comparison purposes. This display can be integrated into the operations of FIGS. 3A-3P (e.g., block 405).

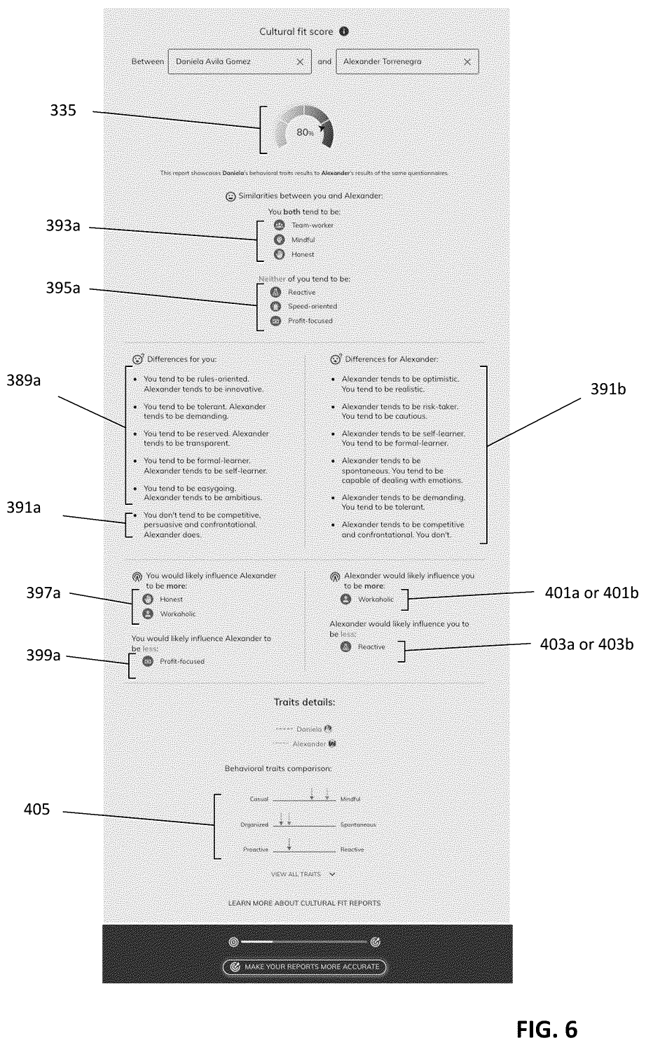

FIG. 6 illustrates another exemplary graphical user interface that is generated by the social network system and communicated to a user device for displaying the groupings of professional traits (or portion thereof) that characterize the compatibility of the particular Source Group (which is an individual user named “Daniela Avila Gomez”) and a particular Target Group (which is an individual user named “Alexander Torrenegra) according to the operations of FIGS. 3A-3P.

The interface of FIG. 6 displays the particular Source Group (which is an individual user named “Daniela Avila Gomez”) and a particular Target Group (which is an individual user named “Alexander Torrenegra) at the top of the display.

The interface of FIG. 6 also display the overall score that quantifies the level of compatibility between the Source Group and the Target Group as calculated in block 335 at the top center part of the display below the particular Source Group and the particular Target Group.

The interface of FIG. 6 also displays a number of professional traits corresponding to the list of “Similar-Have” questions or traits from the perspective of the Source Group in a ranked order (e.g., from more importance to less importance) based on the ranking of 355a as determined in block 393 in the center of the display below the score. These professional traits are associated with the label “Similarities between you and Alexander: You both tend to be:” as shown.

The interface of FIG. 6 also displays a number of professional traits corresponding to the list of “Similar-Don't-Have” questions or traits from the perspective of the Source Group in a ranked order (e.g., from more importance to less importance) based on the ranking of 361a as determined in block 395a in the center of the display below the score. These professional traits are associated with the label “Similarities between you and Alexander: Neither of you tend to be:” as shown.

The interface of FIG. 6 also displays a number of professional traits corresponding to the list “Different-Source-Has” questions or traits from the perspective of the Source Group in a ranked order (e.g., from more importance to less importance) based on the ranking of 343a as determined in block 389a in the left hand side of the display below the score. These Source Group professional traits are associated with the label “Differences for you:” with lead-in text of “You tend to be” for each respective Source Group trait as shown. The interface can also display opposite pair trait(s) to those traits in the list in association with the Target Group. These Target Group traits can be associated with the label “Differences for you:” with lead-in text of “Alexander tends to be” for each respective Target Group trait as shown.

The interface of FIG. 6 also displays a number of professional traits corresponding to the list “Different-Target-Has” questions or traits from the perspective of the Source Group in a ranked order (e.g., from more importance to less importance) based on the ranking of 349a as determined in block 391a in the left hand side of the display below the score. These Target Group professional traits are associated with the label “Differences for you:” with lead-in text of “You don't tend to be” and “Alexander does” for the respective Target Group traits as shown.

The interface of FIG. 6 also displays a number of professional traits corresponding to the list “Different-Target-Has” questions or traits from the perspective of the Target Group in a ranked order (e.g., from more importance to less importance) based on the ranking of 343b as determined in block 391b in the right hand side of the display below the score. These Target Group professional traits are associated with the label “Differences for Alexander:” with lead-in text of “Alexander tends to be” and possibly “You don't” for each respective Target Group trait as shown.

The interface of FIG. 6 also displays a number of professional traits corresponding to the list of “Source-More-Influence-Target” questions or traits from the perspective of the Source Group in a ranked order (e.g., from more importance to less importance) based on the ranking of 367a as determined in block 397a in the left hand side of the display below the score. These professional traits are associated with the label “You would likely influence Alexander to be more:” as shown.

The interface of FIG. 6 also displays a number of professional traits corresponding to the list of “Source-Less-Influence-Target” questions or traits from the perspective of the Source Group in a ranked order (e.g., from more importance to less importance) based on the ranking of 373a as determined in block 399a in the left hand side of the display below the score. These professional traits are associated with the label “You would likely influence Alexander to be less:” as shown.

The interface of FIG. 6 also displays a number of professional traits corresponding to the list of “Target-More-Influence-Source” questions or traits from the perspective of the Source Group in a ranked order (e.g., from more importance to less importance) based on the ranking of 379a as determined in block 401a in the right hand side of the display below the score. Alternatively, the interface of FIG. 6 can display a number of professional traits corresponding to the list of “Target-More-Influence-Source” questions or traits from the perspective of the Target Group in a ranked order (e.g., from more importance to less importance) based on the ranking of 379b as determined in block 401b in the right hand side of the display below the score. These professional traits can be associated with the label “Alexander would likely influence you to be more:” as shown.

The interface of FIG. 6 also displays a number of professional traits corresponding to the list of “Target-Less-Influence-Source” questions or traits from the perspective of the Source Group in a ranked order (e.g., from more importance to less importance) based on the ranking of 385a as determined in block 403a in the right hand side of the display below the score. Alternatively, the interface of FIG. 6 can display a number of professional traits corresponding to the list of “Target-Less-Influence-Source” questions or traits from the perspective of the Target Group in a ranked order (e.g., from more importance to less importance) based on the ranking of 385b as determined in block 403b in the right hand side of the display below the score. These professional traits are associated with the label “Alexander would likely influence you to be less:” as shown.

The interface of FIG. 6 can also display distributions of responses for the Source Group together with the distributions of the responses for the Target Group for questions corresponding to specific professional traits as shown. The distributions can be determined in block 405 as described herein and displayed for comparison purposes.

The interface of FIG. 6 can also include a widget (e.g., labeled “Make Your Reports More Accurate”) that can be selected by the user to enable the user to invite one or more observers to answer the questions to characterize the professional traits of the user, thus collecting response data from the observer(s). Such response data can be processed as part of the method as described hereon to improve the accuracy of the reports.

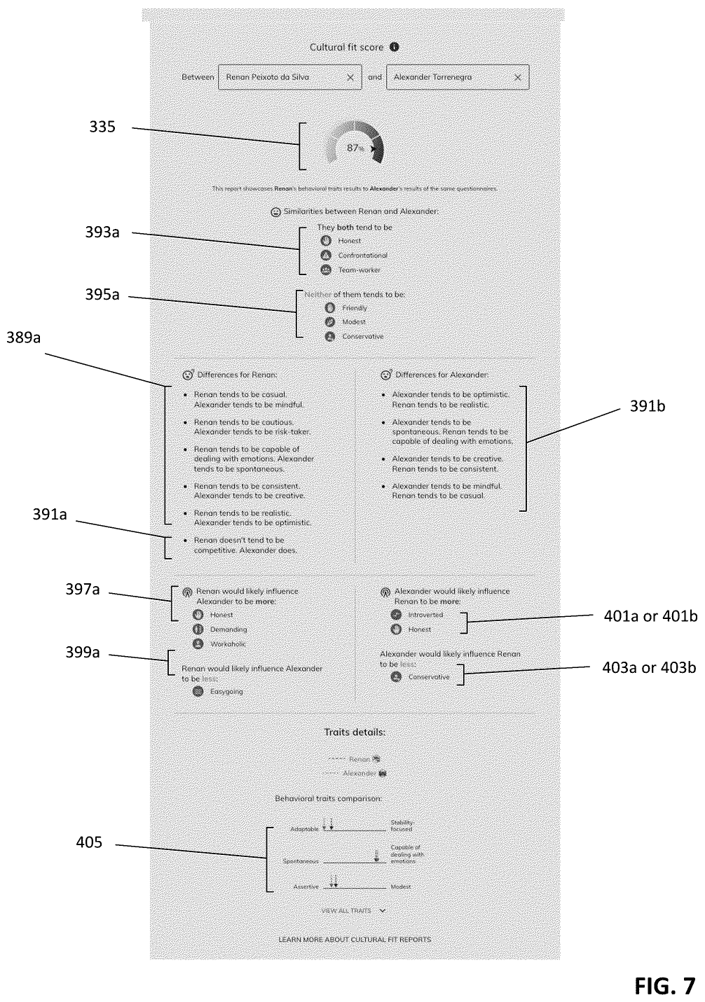

FIG. 7 illustrates yet another exemplary graphical user interface that is generated by the social network system and communicated to a user device for displaying the groupings of professional traits (or portion thereof) that characterize the compatibility of the particular Source Group (which is an individual user named “Renan Peixoto da Silva”) and a particular Target Group (which is an individual user named “Alexander Torrenegra) according to the operations of FIGS. 3A-3P.

The interface of FIG. 7 displays the particular Source Group (which is an individual user named “Renan Peixoto da Silva”) and a particular Target Group (which is an individual user named “Alexander Torrenegra) at the top of the display.

The interface of FIG. 7 also display the overall score that quantifies the level of compatibility between the Source Group and the Target Group as calculated in block 335 at the top center part of the display below the particular Source Group and the particular Target Group.

The interface of FIG. 7 also displays a number of professional traits corresponding to the list of “Similar-Have” questions or traits from the perspective of the Source Group in a ranked order (e.g., from more importance to less importance) based on the ranking of 355a as determined in block 393 in the center of the display below the score. These professional traits are associated with the label “Similarities between Renan and Alexander: They both tend to be:” as shown.

The interface of FIG. 7 also displays a number of professional traits corresponding to the list of “Similar-Don't-Have” questions or traits from the perspective of the Source Group in a ranked order (e.g., from more importance to less importance) based on the ranking of 361a as determined in block 395a in the center of the display below the score. These professional traits are associated with the label “Similarities between Renan and Alexander: Neither of them tend to be:” as shown.

The interface of FIG. 7 also displays a number of professional traits corresponding to the list “Different-Source-Has” questions or traits from the perspective of the Source Group in a ranked order (e.g., from more importance to less importance) based on the ranking of 343a as determined in block 389a in the left hand side of the display below the score. These Source Group professional traits are associated with the label “Differences for Renan:” with lead-in text of “Renan tends to be” for each respective Source Group trait as shown. The interface can also display the opposite pair trait(s) to those in the list in association with the Target Group. These Target Group traits can be associated with the label “Differences for Renan:” with lead-in text of “Alexander tends to be” for each respective Target Group trait as shown.

The interface of FIG. 7 also displays a number of professional traits corresponding to the list “Different-Target-Has” questions or traits from the perspective of the Source Group in a ranked order (e.g., from more importance to less importance) based on the ranking of 349a as determined in block 391a in the left hand side of the display below the score. These Target Group professional traits are associated with the label “Differences for Renan:” with lead-in text of “Renan doesn't tend to be” and “Alexander does” for the respective Target Group traits as shown.

The interface of FIG. 7 also displays a number of professional traits corresponding to the list “Different-Target-Has” questions or traits from the perspective of the Target Group in a ranked order (e.g., from more importance to less importance) based on the ranking of 343b as determined in block 391b in the right hand side of the display below the score. These Target Group professional traits are associated with the label “Differences for Alexander:” with lead-in text of “Alexander tends to be” for each respective Target Group trait as shown. The interface can also display opposite paired trait(s) to those in the list in association with the Source Group. These Source Group traits can be associated with the label “Differences for Renan:” with lead-in text of “Renan tends to be” for each respective Source Group trait as shown.

The interface of FIG. 7 also displays a number of professional traits corresponding to the list of “Source-More-Influence-Target” questions or traits from the perspective of the Source Group in a ranked order (e.g., from more importance to less importance) based on the ranking of 367a as determined in block 397a in the left hand side of the display below the score. These professional traits are associated with the label “Renan would likely influence Alexander to be more:” as shown.

The interface of FIG. 7 also displays a number of professional traits corresponding to the list of “Source-Less-Influence-Target” questions or traits from the perspective of the Source Group in a ranked order (e.g., from more importance to less importance) based on the ranking of 373a as determined in block 399a in the left hand side of the display below the score. These professional traits are associated with the label “Renan would likely influence Alexander to be less:” as shown.

The interface of FIG. 7 also displays a number of professional traits corresponding to the list of “Target-More-Influence-Source” questions or traits from the perspective of the Source Group in a ranked order (e.g., from more importance to less importance) based on the ranking of 379a as determined in block 401a in the right hand side of the display below the score. Alternatively, the interface of FIG. 7 can display a number of professional traits corresponding to the list of “Target-More-Influence-Source” questions or traits from the perspective of the Target Group in a ranked order (e.g., from more importance to less importance) based on the ranking of 379b as determined in block 401b in the right hand side of the display below the score. These professional traits can be associated with the label “Alexander would likely influence Renan to be more:” as shown.

The interface of FIG. 7 also displays a number of professional traits corresponding to the list of “Target-Less-Influence-Source” questions or traits from the perspective of the Source Group in a ranked order (e.g., from more importance to less importance) based on the ranking of 385a as determined in block 403a in the right hand side of the display below the score. Alternatively, the interface of FIG. 7 can display a number of professional traits corresponding to the list of “Target-Less-Influence-Source” questions or traits from the perspective of the Target Group in a ranked order (e.g., from more importance to less importance) based on the ranking of 385b as determined in block 403b in the right hand side of the display below the score. These professional traits are associated with the label “Alexander would likely influence Renan to be less:” as shown.

The interface of FIG. 7 can also display distributions of responses for the Source Group together with the distributions of the responses for the Target Group for questions corresponding to specific professional traits as shown. The distributions can be determined in block 405 as described herein and displayed for comparison purposes.

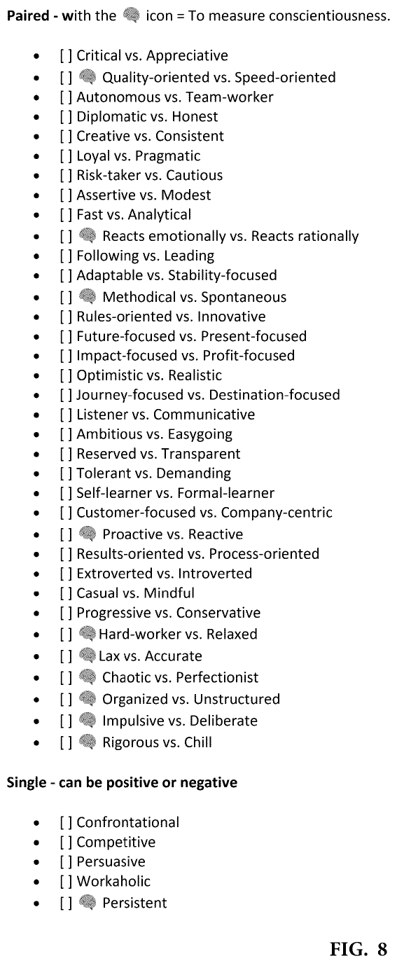

FIG. 8 is a chart that specifies a number of paired professional traits and single professional traits that can be used to evaluate business-oriented compatibility between a source group and a target group of a social network system as described herein.

In one or more embodiments, the individuals of the source group and the target group can include users of a business-oriented social network as described herein. The operations of the methods described herein can be integrated into the functionality of the business-oriented social network.

In one or more embodiments, the individuals of the source group and the target group can include users of a platform or service (such as an online job marketplace or matching network for work). The operations of the methods described herein can be integrated into the functionality of the platform or service.

In one or more of the embodiments, the source group can be one or more individuals or users of the system seeking employment or otherwise considering working with the target group. The target group can be a group of individuals or users of the system that work for a company or otherwise work collectively together (for example, on one or more projects or tasks). Alternatively, the target group can be a single individual or user of the system.

In other embodiments, the individual(s) of the source group and target group can be selected or defined in some other manner and the professional traits of these individuals can be collected, stored and processed to evaluate business-oriented compatibility and cultural fit between the source group and the target group as described herein.

In one or more of the embodiments, the source group can be a group of individuals or users of the system that work for a company or otherwise work collectively together (for example, on one or more projects or tasks). Alternatively, the source group can be a single individual or user of the system. The target group can be one or more individuals or users of the system seeking employment or otherwise considering working with the source group.

In other embodiments, some or all of the professional traits of an individual or user of the system can be determined by analyzing public data (such as social media data) attributable to that individual, apart from the response data submitted in response to a questionnaire by that individual as described herein.

In yet other embodiments, some or all of the professional traits of an individual or user of the system can be determined by analyzing private data (such as text messages or email messages) attributable to that individual, apart from the response data submitted in response to a questionnaire by that individual as described herein.

In still other embodiments, some or all of the professional traits of an individual or user of the system as determined from the response data submitted in response to a questionnaire by that individual can be verified as correct (or possibly marked as incorrect and ignored or marked for further processing and verification) by analyzing public data (such as social media data) and/or private data (such as text messages or email messages) attributable to that individual.

In other embodiments, when looking for candidates or analyzing job applicants, companies and job posters can specify one or more specific professional traits that are desirable or required (for example, because the company is weak in or lack the specific professional trait(s)), and the methods and systems described herein can be adapted to identify individuals (candidates or applicants) that have the specific professional trait(s) and thus will aid in diversifying the company.

The methods and systems as described herein provide a number of advantages that are not found in prior art business-oriented social networking systems, including, but not limited, to the following:
The computer-based methods and systems convey information as part of a dynamic graphical user interface that characterizes compatibility and culture fit for a source group and a target group (such as company with a job opening) from the perspective of the source group together with information that characterizes compatibility and culture fit for the source group and target group from the perspective of the target group; for example, the source group can be a prospective candidate or job seeker, and the target group can be a company with a job opening. The information conveyed by the graphical user interface can include i) information that identifies well-matched professional traits of the individual of the source group and the target group in a ranked order, both from the prospective of the individual(s) of the source group and from the prospective of the individual(s) of the target group, ii) information that identifies mismatched (differences in) professional traits of the individuals of the source group and the target group in a ranked order, both from the prospective of the individual(s) of the source group and from the prospective of the individual(s) of the target group; and iii) information that identifies likely influence on professional traits of the individuals of the source group and the target group in a ranked order (which assumes that the individuals of the source group and the target group work together), both from the prospective of the individual(s) of the source group and from the prospective of the individual(s) of the target group. Such information provides a more complete view of the similar and the different professional traits between the source group and the target group in a ranked order, both from the prospective of the individual(s) of the source group and from the prospective of the individual(s) of the target group, as well as likely influence of the source group on the target group and vice versa. Such information characterizes or predicts the ability (or inability) of the individuals of the source group and the target group to work together in harmony. It can also highlight different professional traits between the source group and the target group that can aid in diversifying or influencing the traits of the source group or the target group when desired. Such information can be used to make a well-informed decision related to the source group and the target group working together, particularly in comparison to considering the matching or different professional traits of the individuals of the source group and the target group from only one perspective.
The computer-based methods and systems automate the analysis of compatibility and culture fit between the source group and the target group; this can save time and money by identifying cases where there is a relatively high level of compatibility and culture fit between the source group and the target group and relatively low level of compatibility and culture fit between the source group and the target group. For cases where there is a relatively high level of compatibility and culture fit, one or more individuals of the source group and target group can initiate further communication and/or meetings (such as an interview) with regards to formally working together. For cases where there is a relatively low level of compatibility and culture fit, the further communication and/or meetings (such as an interview) can be avoided thus saving time and money.
The computer-based methods and systems enable the matching of candidates, job openings, and teams, so that matching candidates can be identified by companies when sourcing candidates, and matching jobs and teams can be identified by candidates when looking for jobs or getting job alerts;
The computer-based analysis enables the matching of potential employees to a company as well as the matching of potential consultants, freelancers, advisors, co-founders, board members, etc. to a company. The computer-based methods and system provide analysis of compatibility and culture fit between the source group and the target group can reduce discrimination and subjectiveness from the recruitment process.
The computer-based methods and systems provide analysis of compatibility and culture fit between the source group and the target group can help identify culture and compatibilities areas that are likely to be missed by traditional processes.

Certain embodiments as described herein can include logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules include a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules may provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program may be written in any form of programming language, including compiled or interpreted languages, and it may be deployed in any form, including as a stand-alone program or as a module, subroutine, or other unit suitable for use in a computing environment. A computer program may be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations may also be performed by, and apparatus of example embodiments may be implemented as, special purpose logic circuitry, e.g., a field programmable gate array (FPGA) or an application-specific integrated circuit (ASIC).

The computing system may include clients and servers. A client and server are generally remote from each other and typically interact through a communication network. The relationship of client and server arises by virtue of computer programs running on the respective computers and having a client-server relationship with each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

FIG. 9 shows a diagrammatic representation of a machine in the example form of a computer system 600 within which a set of instructions for causing the machine to perform any one or more of the methods, processes, operations, or methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a Personal Computer (PC), a tablet PC, a Personal Digital Assistant (PDA), a cellular telephone or smartphone, a Web appliance, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Example embodiments may also be practiced in distributed system environments where local and remote computer systems which that are linked (e.g., either by hardwired, wireless, or a combination of hardwired and wireless connections) through a network, both perform tasks. In a distributed system environment, program modules may be located in both local and remote memory-storage devices (see below).

The example computer system 600 includes a processor 602 (e.g., a Central Processing Unit (CPU), a Graphics Processing Unit (GPU) or both), main memory 601 and static memory 606, which communicate with each other via a bus 608. The computer system 600 may further include a video display unit 610, an alphanumeric input device 612 (e.g., a keyboard), a User Interface (UI) cursor controller 614 (e.g., a mouse), a disk drive unit 616, an audio device 618 (e.g., a speaker) and a network interface device 620.

The disk drive unit 618 includes a machine-readable medium 622 on which is stored one or more sets of instructions 624 and data structures (e.g., software) embodying or used by one or more of the methodologies or functions illustrated herein. The software may also reside, completely or at least partially, within the main memory 601 and/or within the processor 602 during execution thereof by the computer system 600. In this manner, the main memory 601 and the processor 602 also constitute machine-readable media.

The instructions 624 may further be transmitted or received over a network 626 via the network interface device 620 using any one of a number of well-known transfer protocols (e.g., HTTP).

The term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any of the one or more of the methodologies illustrated herein. The term “machine-readable medium” shall accordingly be taken to include, but not be limited to, solid-state memories, and optical and magnetic medium.

Method embodiments illustrated herein may be computer-implemented. Some embodiments may include computer-readable media encoded with a computer program (e.g., software), which includes instructions operable to cause an electronic device to perform methods of various embodiments. A software implementation (or computer-implemented method) may include microcode, assembly language code, or a higher-level language code, which further may include computer readable instructions for performing various methods. The code may form portions of computer program products. Further, the code may be tangibly stored on one or more volatile or non-volatile computer-readable media during execution or at other times. These computer-readable media may include, but are not limited to, hard disks, removable magnetic disks, removable optical disks (e.g., compact disks and digital video disks), magnetic cassettes, memory cards or sticks, Random Access Memories (RAMs), Read Only Memories (ROMs), and the like.

The above detailed description includes references to the accompanying drawings, which form a part of the detailed description. The drawings show, by way of illustration, specific embodiments in which the invention may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a non-exclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope of the present disclosure. Also, in the above Detailed Description, various features may be grouped together to streamline the disclosure. This should not be interpreted as intending that any disclosed feature is essential to the present disclosure. Rather, inventive subject matter may lie in less than all features of a particular disclosed embodiment.

We claim:

1. A computer-implemented method for characterizing compatibility between a source group and a target group, the method comprising:
for each given individual of the source group, interacting with the given individual of the source group to obtain and store response data to an electronic-form questionnaire related to a predefined set of professional traits;
for each given individual of the target group, interacting with the given individual of the target group to obtain and store response data to the same or similar electronic-form questionnaire related to the predefined set of professional traits;
processing the response data for the at least one individual of the source group and the response data for the at least one individual of the target group to generate a score related to compatibility of the source group and the target group;
processing the response data for the at least one individual of the source group and the response data for the at least one individual of the target group to assign professional traits to labels that relate to compatibility of the source group and the target group for highlight purposes; and
presenting for display the score and additional information for evaluation of compatibility of the source group and the target group, wherein the additional information is based on the assignment of professional traits to labels.

2. A method according to claim 1, wherein:
the score and additional information characterizes the natural ability of the individuals of the source group and the target group to work together in harmony because of well-matched characteristics and cultural fit.

3. A method according to claim 1, wherein:
the individuals of the source group and the target group includes users of a business-oriented social network or other platform or service.

4. A method according to claim 1, further comprising:
interacting with at least one observer of the at least one individual of the source group to obtain and store response data to the same or similar electronic-form questionnaire related to the predefined set of professional traits of the least one individual of the source group; and
interacting with at least one observer of the at least one individual of the target group to obtain and store response data to the same or similar electronic-form questionnaire related to the predefined set of professional traits of the least one individual of the target group;
wherein the observer response data for source group and the observer response data for the target group are processed to assign the labels to the predefined set of professional traits.

5. A method according to claim 1, wherein:
the additional information conveys the effect of the predefined set of professional traits on the compatibility of the source group and the target group.

6. A method according to claim 5, wherein:
at least part of the additional information conveys the effect of the predefined set of professional traits on the compatibility of the source group and the target group from the perspective of the source group.

7. A method according to claim 5, wherein:
at least part of the additional information conveys the effect of the predefined set of professional traits on the compatibility of the source group and the target group from the perspective of the target group.

8. A method according to claim 1, wherein:
the labels represent at least one class of professional traits where the source group and the target group likely both have a professional trait.

9. A method according to claim 1, wherein:
the labels represent at least one class of professional traits where the source group and the target group likely both do not have a professional trait.

10. A method according to claim 1, wherein:
the labels represent at least one class of professional traits where the source group likely has a professional trait and the target group likely does not have the professional trait.

11. A method according to claim 1, wherein:
the labels represent at least one class of professional traits where the target group likely has a professional trait and the source group likely does not have the professional trait.

12. A method according to claim 1, wherein:
the labels represent at least one class of professional traits where the source group would likely influence the target group to have more of a professional trait.

13. A method according to claim 1, wherein:
the labels represent at least one class of professional traits where the source group would likely influence the target group to have less of a professional trait.

14. A method according to claim 1, wherein:
the labels represent at least one class of professional traits where the target group would likely influence the source group to have more of a professional trait.

15. A method according to claim 1, wherein:
the labels represent at least one class of professional traits where the target group would likely influence the source group to have less of a professional trait.

16. A method according to claim 1, wherein:
the score is generated from question-specific calculations that generate statistical parameters that account for response data collected from a larger number of individuals beyond the source group and the target group.

17. A method according to claim 1, wherein:
the score is generated from
i) question-specific relevance factors with respect to the source group that represent weights that reflect amount of separation in the responses of the source group relative to question-specific global averages and deviations, and
ii) question-specific relevance factors with respect to the target group that represent weights that reflect amount of separation in the responses of the target group relative to the question-specific global averages and deviations.

18. A method according to claim 1, wherein:
the score is generated from question-specific similarity factors that reflect similarity or difference between the responses of the source group and the target group.

19. A method according to claim 1, wherein:
the score is generated from
i) question-specific importance factors with respect to the source group that are based on distribution of responses in the source group, and
ii) question-specific importance factors with respect to the target group that are based on distribution of responses in the target group.

20. A method according to claim 19, wherein:
the score is generated by
i) adjusting question-specific similarity factors that reflect similarity or difference between the responses of the source group and the target group, wherein the adjusting is based on the question-specific importance factors with respect to the source group; and
ii) adjusting question-specific similarity factors that reflect similarity or difference between the responses of the source group and the target group, wherein the adjusting is based on the question-specific importance factors with respect to the target group.

21. A method according to claim 20, wherein:
i) the score is generated from accumulating question-specific adjusted similarity factors with respect to the source group for a plurality questions and accumulating question-specific importance factors with respect to the source group for a plurality questions; and/or
ii) the score is generated from accumulating question-specific adjusted similarity factors with respect to the target group for a plurality questions and accumulating question-specific importance factors with respect to the target group for a plurality questions; and/or
iii) combining scores derived from the accumulating of i) and the accumulating of ii).

22. A method according to claim 1, further comprising:
ranking professional traits that relate to the compatibility of the source group and the target group from the perspective of the source group, wherein the ranking is based on question-specific factors with respect to the source group.

23. A method according to claim 22, wherein:
the question-specific factors with respect to the source group comprise question-specific relevance factors with respect to the source group that represent weights that reflect amount of separation in the responses of the source group relative to a question-specific global averages and deviations.

24. A method according to claim 1, further comprising:
ranking professional traits that relate to the compatibility of the source group and the target group from the perspective of the target group, wherein the ranking is based on question-specific factors with respect to the target group.

25. A method according to claim 24, wherein:
the question-specific factors with respect to the target group comprise question-specific relevance factors with respect to the target group that represent weights that reflect amount of separation in the responses of the target group relative to a question-specific global averages and deviations.

26. A method according to claim 1, wherein the labels are configured to include:
i) labels that correspond to at least one class of professional traits where the source group would likely influence the target group to have more of a professional trait;
ii) labels that correspond to at least one class of professional traits where the source group would likely influence the target group to have less of a professional trait;
iii) labels that correspond to at least one class of professional traits where the target group would likely influence the source group to have more of a professional trait; and
iv) labels that correspond to at least one class of professional traits where the target group would likely influence the source group to have less of a professional trait.

27. A method according to claim 26, further comprising:
assigning professional traits to the classes of i) to iv) based on statistical parameters that account for differences between the responses of the source group and the responses of the target group.

28. A method according to claim 26, further comprising:
assigning professional traits to the classes of i) and ii) based on statistical parameters calculated from the response data for the target group as provided by individual(s) and/or observer(s) of the target group.

29. A method according to claim 26, further comprising:
assigning professional traits to the classes of iii) and iv) based on statistical parameters calculated from the response data for the source group as provided by individual(s) and/or observer(s) of the source group.

30. A computer processing system configured to implement the method of claim 1.
